(19) United States
(12) Patent Application Publication
(10) Pub. No.: US 2011/0006255 A1
(43) Pub. Date: Jan. 13, 2011

(54) METHOD FOR FABRICATING A MOLTEN PRODUCT BASED ON LANTHANUM AND MANGANESE

(75) Inventors: Caroline Levy, Montpellier (FR); Samuel Marlin, Plan d'Orgon (FR)

Correspondence Address: Oliff & Berridge, PLC, P.O. Box 320850, Alexandria, VA, 22320-4850, US

(73) Assignee: SAINT-GOBAIN CENTRE DE RECHERCHES ET D'ETUDES EUROPEEN, Courbevoie (FR)

(21) Appl. No.: 12/808,861

(22) PCT Filed: Dec. 22, 2008
(86) PCT No.: PCT/FR2008/052399

§ 371 Date: Sep. 23, 2010

(30) Foreign Application Priority Data
Dec. 21, 2007 (FR) 0760240

(51) Int. Cl. H01M 4/90; C22B 9/00; B22F 9/06; B22D 29/00; C21D 1/00

(52) U.S. Cl. 252/182.1; 75/414; 75/338; 164/131; 148/538

(57) ABSTRACT

The present invention relates to a molten product comprising: the element lanthanum (La), an element (Ln) selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), and mixtures thereof, the element cerium (Ce), an element Qa selected from the group consisting of calcium (Ca), strontium (Sr), barium (Ba) and mixtures thereof, the element manganese (Mn), an element Qb selected from the group consisting of magnesium (Mg), nickel (Ni), chromium (Cr), aluminum (Al), iron (Fe), cobalt (Co), titanium (Ti), tin (Sn), tantalum (Ta), indium (In), niobium (Nb) and mixtures thereof, the element oxygen (O).

### TECHNICAL FIELD

The invention relates to a method for fabricating a product comprising:
the element lanthanum (La),
optionally, an element Ln selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), and mixtures thereof,
optionally, the element cerium (Ce),
an element Qa selected from the group consisting of calcium (Ca), strontium (Sr), barium (Ba) and mixtures thereof,
the element manganese (Mn),
optionally, an element Qb selected from the group consisting of magnesium (Mg), nickel (Ni), chromium (Cr), aluminum (Al), iron (Fe), cobalt (Co), titanium (Ti), tin (Sn), tantalum (Ta), indium (In), niobium (Nb) and mixtures thereof,
the element oxygen (O)

In the rest of the description, such a product is called “product based on lanthanum and manganese”. The invention also relates to such a product when it is obtained by fusion.

### PRIOR ART

Products based on lanthanum and manganese are used in particular for the fabrication of solid oxide fuel cell (SOFC) cathodes, as described for example in U.S. Pat. No. 4,562,124, EP 0 577 420, U.S. Pat. No. 5,342,704, EP 0 639 866, U.S. Pat. No. 5,686,198, U.S. Pat. No. 5,916,700 or U.S. Pat. No. 6,492,051. These SOFC cathodes are generally synthesized industrially by solid phase sintering after shaping by pressing.

The powders of products based on lanthanum and manganese are generally also produced by solid phase sintering methods, as described for example in U.S. Pat. No. 5,686,198.

Powders of products based on lanthanum and magnesium today are very costly.

A need therefore exists for a novel method for fabricating products based on lanthanum and manganese at reduced cost and in industrial quantities.

It is one object of the invention to satisfy this need.

Furthermore, in solid oxide fuel cells (SOFC) today, each electrode is generally divided into two layers. In the particular case of the cathode, a first layer plays the role of a current collector (CCL). One of the raw materials used as a cathode material in the SOFC technology is a powder of doped lanthanum-manganese perovskite ((La_{(1-w-x-y)}Ln_{w}Ceₓ Qa_{y})ₛ(Mn_{(1-z)}Qb_{z})O_{3-δ}).

The functional layer in the cathode (CFL), located between the CCL layer and the electrolyte, must serve both to supply electrons to the system to reduce the oxygen in the air to O²⁻ ions, and to transport these O²⁻ ions to the electrolyte. For this purpose, the functional layer CFL is generally composed of a mixture of an ion conducting material and an electron conducting material (doped lanthanum-manganese perovskite (La_{(1-w-x-y)}Ln_{w}CeₓQa_{y})ₛ(Mn_{(1-z)}Qb_{z})O_{3-δ}). The contact between the two materials and the air must be optimal, that is, the number of triple points must be a maximum, and percolation of the grains must occur for each material.

Doped zirconias (cubic zirconia stabilized with yttrium oxide, cubic zirconia stabilized with scandium, etc.) are commonly used as electrolyte materials or in the cathode functional layer.

The contact between the doped zirconia powder and the doped lanthanum-manganese perovskite powder (La_{(1-w-x-y)}Ln_{w}CeₓQa_{y})ₛ(Mn_{(1-z)}Qb_{z})O_{3-δ} is therefore intimate and the number of contact points between the two powders is high.

In fact, the doped lanthanum-manganese perovskites (La_{(1-w-x-y)}Ln_{w}CeₓQa_{y})ₛ(Mn_{(1-z)}Qb_{z})O_{3-δ} of the cathode material may react with the doped zirconia of the electrolyte or of the cathode functional layer to form new phases at their interface, in particular:
a phase of the pyrochlore type La₂Zr₂O₇, particularly when, in the perovskite formula of (La_{(1-w-x-y)}Ln_{w}CeₓQa_{y})ₛ(Mn_{(1-z)}Qb_{z})O_{3-δ}, (1-w-x-y) is lower than 0.4, or even lower than 0.3 and/or
phases of the type QaₐZr_{b}O_{c}, a, b and c being integers and/or
phases of the type La_{d}QaₑZr_{f}Qb_{g}Oₕ with d, f, h being strictly positive real numbers, and e and g being positive real numbers or zero satisfying the equation if e=0 then g≠0 and if g=0 then e≠0.

The presence of a pyrochlore phase reduces the performance of the cell.

In order to increase the performance of SOFC cells, a need therefore exists for a doped lanthanum-manganese perovskite (La_{(1-w-x-y)}Ln_{w}CeₓQa_{y})ₛ(Mn_{(1-z)}Qb_{z})O_{3-δ}, suitable for only forming a small quantity of phases of the pyrochlore type La₂Zr₂O₇ and/or QaₐZr_{b}O_{c} and/or La_{d}QaₑZr_{f}Qb_{g}Oₕ when it is in contact with a doped zirconia powder.

It is another object of the invention to satisfy this need.

### SUMMARY OF THE INVENTION

The invention proposes a fabrication method (called “general method”) comprising the following steps:
a) mixing of raw materials providing lanthanum, magnesium, an element Qa and optionally an element Ln and/or an element Qb and/or cerium, and preferably oxygen, to form a starting charge,
   the element Qa being selected from calcium (Ca), strontium (Sr), barium (Ba) and mixtures thereof,
   the element Ln being selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (TM), ytterbium (Yb), lutetium (Lu), yttrium (Y), and mixtures thereof,
   the element Qb being selected from the group consisting of magnesium (Mg), nickel (Ni), chromium (Cr), aluminum (Al), iron (Fe), cobalt (Co), titanium (Ti), tin (Sn), tantalum (Ta), indium (In), niobium (Nb) and mixtures thereof,
b) melting of the starting charge until a bath of melting material is obtained;
c) cooling to complete solidification of said melting material,
   the raw materials being selected so that, by denoting:
Laₚ the molar content of lanthanum;
Mnₚ the molar content of manganese;
Lnₚ the molar content of the element Ln;
Ceₚ the molar content of cerium;
Qaₚ the molar content of element Qa;
Qbₚ the molar content of element Qb;
   these contents being expressed as molar percentages on the basis of the total molar quantity of the elements La, Ln, Ce, Qa, Mn, Qb, and by setting
s=(Laₚ+Lnₚ+Ceₚ+Qaₚ)/(Mnₚ+Qbₚ),
z=Qbₚ/(Mnₚ+Qbₚ),
w=Lnₚ/(Laₚ+Lnₚ+Ceₚ+Qaₚ),
x=Ceₚ/(Laₚ+Lnₚ+Ceₚ+Qaₚ), and
y=Qaₚ/(Laₚ+Lnₚ+Ceₚ+Qaₚ),
   the solid product obtained after step c), called “molten product”, has a chemical composition such that,
0≦w≦0.4, and
0≦x≦0.4, and
0.1≦y≦0.6, and
0≦z≦0.5, and
0.8≦s≦1.25.

By simple adjustment of the composition of the starting charge, conventional fusion methods thereby serve to fabricate, from a bath of melting material, molten products of different sizes, for example in the form of particles or blocks, having advantageous compositions.

Furthermore, the inventors have discovered surprisingly that this process of fabrication by fusion serves to obtain, optionally after annealing, products which have a proportion of perovskite, in particular of perovskite (La_{(1-w-x-y)}Ln_{w}CeₓQa_{y})ₛ(Mn_{(1-z)}Qb_{z})O_{3-δ}, w, x, y, z and s being molar proportions and δ corresponding to the value required to ensure electroneutrality. These products can thus be used advantageously, for example, for the fabrication of solid oxide fuel cell cathodes.

Furthermore, as will be shown in greater detail in the rest of the description, a product according to the invention, when placed in contact with the zirconia powder doped with yttrium oxide, systematically generates less of the pyrochlore type of phase La₂Zr₂O₇ and/or phases of the type QaₐZr_{b}O_{c} and/or La_{d}QaₑZr_{f}Qb_{g}Oₕ than the products having the same composition according to the prior art, and in particular than sintered products. It is therefore particularly suitable for the fabrication of SOFC cathodes.

A fabrication method according to the invention may further comprise even one, or more, of the following general optional features:
The elements La, Ln, Ce, Qa, Mn, Qb, and O preferably account for, in weight percent, more than 95%, preferably more than 98.5%, preferably more than 99%, preferably more than 99.3%, or even more than 99.6% of the solid product obtained after step c);
The complement to 100% preferably consists of impurities;
Preferably, the impurities are all elements other than lanthanum, the element Ln, cerium, manganese, the element Qa, the element Qb, the element oxygen and combinations thereof;
The starting charge is adapted so that at the end of step c), the weight content of impurities, expressed in the form of oxides, of the molten product, is lower than 1.5%, preferably lower than 1%, preferably lower than 0.7%, preferably even lower than 0.4%. Even more preferably,
   SiO₂<0.1%, preferably SiO₂<0.07%, preferably SiO₂<0.06%, and/or
   ZrO₂<0.5%, preferably ZrO₂<01%, preferably ZrO₂<0.05%, and/or
   Na₂O<0.1%, preferably Na₂O<0.07%, preferably Na₂O<0.05%;
The raw materials are selected so that at the end of step c), the molten product has a value of the parameter s of between 0.85 and 1.15, preferably between 0.90 and 1.10, preferably between 0.90 and 1.00, even more preferably between 0.95 and 1.00;
The lanthanum, manganese, the element Qa and optionally the element Qb, cerium and the element Ln are preferably provided in the starting charge by precursor compounds of these elements. Preferably, said precursors are selected from the group of oxides, carbonates, hydrates, nitrates, oxalates and mixtures thereof. Even more preferably, said precursors are selected from the group of oxides, carbonates and mixtures thereof;
At least one of the elements lanthanum, element Ln, element Qa, element Qb, cerium and manganese is introduced in oxide form;
The compounds providing lanthanum, manganese, the element Qa and optionally the element Qb, cerium and the element Ln account for more than 90%, preferably more than 99%, as weight percent, of the constituents of the starting charge. Preferably, these compounds, together with the impurities, account for 100% of the constituents of the starting charge;
The product obtained at the end of step c) may have a perovskite content of LaLnCeQaMnQb, not including impurities, higher than 30%, preferably higher than 50%, preferably higher than 70%, preferably higher than 85%, preferably higher than 90%, preferably even higher than 95%, or even higher than 96%;
The starting charge is determined so that the molten product is electrically neutral;
The starting charge comprises oxides and/or carbonates and/or hydrates and/or nitrates and/or oxalates in order to provide oxygen, preferably in a quantity for ensuring the electroneutrality of the molten product. The oxygen may also be supplied, at least partially, by the gaseous environment during the fusion. In particular, the fusion may thus be carried out in oxidizing conditions;
The molten product has a molar content Oₚ of the element oxygen, as a molar percent on the basis of the total molar quantity of the elements La, Ln, Ce, Qa, Mn, Qb, O, such that 2/(3+s)≦Oₚ, or even 2.5/(3.5+s)≦Oₚ, or even 2.7/(3.7+s)≦Oₚ, or even 2.8/(3.8+s)≦Oₚ, or even 2.85/(3.85+s)≦Oₚ and/or Oₚ4/(5+s), or even Oₚ≦3.5/(4.5+s), or even Oₚ≦3.3/(4.3+s), or even Oₚ≦3.2/(4.2+s), or even Oₚ≦3.15/(4.15+s), or even Oₚ=3/(4+s).
The starting charge is determined so that, in the molten product, z>0;
The starting charge is determined so that, in the molten product, z=0 and:
   1.1<s≦1.26 or
   0.8≦s≦1.1 and
   w is different from 0 and Ln is not Yb and/or Y or
   w is different from 0 and Ln is equal to Yb and/or Y and x+y+w>0.6875 or
   w=0 and (x+y).s>0.55;
The starting charge is determined so that the molten product is not a product described in WO2008050063.

In a first alternative of the general method of the invention, the element Qa is selected from the group consisting of calcium (Ca), strontium (Sr), barium (Ba) and mixtures thereof, preferably calcium (Ca); the element Qb is selected from the group consisting of magnesium (Mg), nickel (Ni), chromium (Cr), aluminum (Al), iron (Fe), cobalt (Co), titanium (Ti), tin (Sn), tantalum (Ta), indium (In), niobium (Nb) and mixtures thereof and
0.05≦x≦0.25, preferably 0.1≦x≦0.2 and
0.1≦x+y≦0.7, preferably 0.4≦x+y≦0.7, and
0≦z≦0.5, and
0.8≦s≦1.25, preferably 0.85≦s≦1.15, preferably 0.9≦s≦1.1, preferably 0.9≦s≦1, preferably 0.95≦s≦1.

Preferably, w=0.

In a first particular embodiment of the first alternative of the general method of the invention:
0<z≦0.5, and
0.05≦x≦0.25, preferably 0.1≦x≦0.2 and
0.1≦x+y≦0.7, preferably 0.4≦x+y≦0.7, and
0.8≦s≦1.25, preferably 0.85≦s≦1.15, preferably 0.9≦s≦1.1, preferably 0.9≦s≦1, preferably 0.95≦s≦1.

Preferably, w=0.

In a second particular embodiment of the first alternative of the general method of the invention:
z=0, and
0.05≦x≦0.25, preferably 0.1≦x≦0.2 and
0.1≦x+y≦0.7, preferably 0.4≦x+y≦0.7, and
0.80≦s<0.9

Preferably, w=0.

In a third particular embodiment of the first alternative of the general method of the invention:
z=0, and
0.05≦x≦0.25, preferably 0.1≦x≦0.2 and
0.5<x+y≦0.7, and
0.8≦s≦1.25, preferably 0.85≦s≦1.15, preferably 0.9≦s≦1.1, preferably 0.9≦s≦1, preferably 0.95≦s≦1.

Preferably, w=0.

For example, according to the first alternative,
Qa is Ca, and
z=0, and
x=0.2, and
y=0.5, and
s=1.

In a second alternative of the general method of the invention, the element Qa is calcium (Ca), the element Qb is chromium (Cr), and
0.18≦y≦0.4, and
0.05≦z≦0.15, and
0.8≦s≦1.25, preferably 0.85≦s≦1.15, preferably 0.9≦s≦1.1, preferably 0.9≦s≦1, preferably 0.95≦s≦1.

Preferably, w=0 and x=0.

For example, according to the second alternative,
x=0 and
w=0 and
z=0.125 and
y=0.222, and
s=0.9.

In a third alternative of the general method of the invention, the element Qa is selected from the group consisting of calcium (Ca), strontium (Sr), and mixtures thereof, and
0.01≦x≦0.047, and
0.155≦y≦0.39, and
0.80≦s≦1.25, preferably 0.85≦s≦1.15, preferably 0.90≦s≦1.1, preferably 0.9≦s≦1, preferably 0.95≦s≦1, even more preferably 0.96≦s≦0.995.

Preferably, w=0 and z=0.

In a first particular embodiment of the third alternative of the general method of the invention: 0.80≦s<0.9.

In a fourth alternative of the general method of the invention, the element Qa is selected from the group consisting of calcium (Ca), strontium (Sr), and mixtures thereof; the element Qb is selected from the group consisting of nickel (Ni), chromium (Cr), and mixtures thereof, and
0≦x≦0.205, and
0.15≦y≦0.25, preferably y=0.2, and
0.03≦z≦0.2, and
0.8≦s≦1.25, preferably 0.85≦s≦1.15, preferably 0.9≦s≦1.1, preferably 0.9≦s≦1, preferably 0.95≦s≦1.

Preferably, w=0.

For example, according to the fourth alternative:
Qa is Ca, and
Qb is Ni, and
w=0 and
z=0.125, and
x=0.1, and
y=0.2, and
s=1.

Also for example:
Qa is Ca, and
Qb is a molar mixture of ⅔ Cr and ⅓ Ni, and
w=0 and
z=0.06 and
x=0.105, and
y=0.199, and
s=1.005.

Still for example:
Qa is Ca, and
Qb is a molar mixture of ½ Cr and ½ Ni, and
w=0 and
z=0.125 and
x=0.1, and
y=0.2, and
s=1.

In a fifth alternative of the general method of the invention, the element Ln is selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and mixtures thereof, preferably selected from the group consisting of praseodymium (Pr), neodymium (Nd), samarium (Sm), and mixtures thereof; the element Qa is selected from the group consisting of calcium (Ca), strontium (Sr), barium (Ba), and mixtures thereof; the element Qa is preferably calcium; the element Qb is selected from the group consisting of magnesium (Mg), nickel (Ni), chromium (Cr), aluminum (Al), iron (Fe), and mixtures thereof, preferably from the group consisting of nickel (Ni), magnesium (Mg) and mixtures thereof, and
0.05≦w≦0.4, preferably 0.05≦w≦0.3, even more preferably 0.05≦w≦0.2 and
0≦x≦0.4, preferably 0≦x≦0.3, even more preferably 0≦x≦0.2 and
0.1≦y≦0.2, and
0.05≦z≦0.1, and
0.8≦s≦1.25, preferably 0.85≦s≦1.15, preferably 0.9≦s≦1.1, preferably 0.9≦s≦1, preferably 0.95≦s≦1.

In a sixth alternative of the general method of the invention, the element Ln is selected from the group consisting of neodymium (Nd), samarium (Sm), gadolinium (Gd), dysprosium (Dy), erbium (Er), yttrium (Y), and mixtures thereof, preferably the element Ln consists of an element selected from the group consisting of samarium (Sm), gadolinium (Gd), dysprosium (Dy), erbium (Er), and mixtures thereof, preferably the element Ln is samarium (Sm); the element Qa is calcium (Ca), and
0.005≦w≦0.4, preferably 0.175≦w≦0.185, and
0.005≦x≦0.02, and
0.1≦y≦0.6, preferably 0.255≦y≦0.265, and
0.8≦s≦1.25, preferably 0.85≦s≦1.15, preferably 0.9≦s≦1.1, preferably 1≦s≦1.02, even more preferably 1.001≦s≦1.01, and a preferably 0.55≦1-w-x-y≦0.56.

Preferably, z=0.

For example, according to the sixth alternative:
Qa is Ca, and
Ln is selected from the group consisting of neodymium (Nd), samarium (Sm), gadolinium (Gd), dysprosium (Dy), erbium (Er), yttrium (Y), and mixtures thereof, for example also Ln is Sm or Gd or Dy.
w=0.179, and
z=0, and
x=0.01, and
y=0.259, and
s=1.005.

In a seventh alternative of the general method of the invention, the element Qa is calcium (Ca), and
0.1≦x≦0.2, and
0.2≦y≦0.55, and
0.8≦s≦1.25, preferably 0.85≦s≦1.15, preferably 0.9≦s≦1.1, preferably 0.9≦s≦1, preferably 0.95≦s≦1.

Preferably, w=0 and z=0.

According to a first particular embodiment of the seventh alternative of the invention:
0.1≦x≦0.2, and
0.5<x+y≦0.75, and
0.8≦s≦1.25, preferably 0.85≦s≦1.15, preferably 0.9≦s≦1.1, preferably 0.9≦s≦1, preferably 0.95≦s≦1.

Preferably, w=0 and z=0.

The invention also relates to the product according to the invention issuing from step c).

In a first version of the general method, the invention relates to a method for fabricating particles of a product according to the invention.

The invention relates in particular to a fabrication method comprising the steps a), b) described above in the context of the general fabrication method, and denoted, for this first version of the general method, “a₁)” and “b₁)”, respectively, and a step c) comprising the following steps:
c₁) dispersion of the melting material in the form of liquid droplets,
d₁) solidification of these liquid droplets by contact with an oxygen-containing fluid, in order to obtain molten particles.

By a simple adjustment of the composition of the starting charge, conventional dispersion methods, in particular by blowing or spraying, thereby serve to fabricate, from a bath of melting material, particles of a product according to the invention.

In this first version of the general method, the fabrication method may also comprise one, or more, of the general optional features listed below and/or the following particular optional features:
In step b₁), neither a plasma torch nor a heat gun is used. For example, an arc furnace is used. Advantageously, the productivities thereby improve. Furthermore, the methods using a plasma torch or a heat gun do not generally allow the fabrication of particles larger than 200 microns in size, or at least larger than 500 microns;
In step c₁) and/or step d₁), said melting material and/or said liquid droplets in the course of solidification are placed in contact with an oxygen-containing fluid, preferably identical for step c₁) and for step d₁);
The oxygen-containing fluid, preferably gas, for example air, comprises at least 20%, or even at least 25%, by volume of oxygen;
The dispersion and solidification steps are simultaneous;
Contact is maintained between the droplets and the oxygen-containing fluid until complete solidification of said droplets;
After step d₁), the molten particles are annealed. Preferably, the particles are annealed at a temperature of between 1050° C. and 1700° C., preferably between 1200° C. and 1650° C., preferably between 1450° C. and 1650° C., for a temperature holding time preferably longer than 2 hours, preferably longer than 5 hours, 10 hours, preferably longer than 15 hours, preferably longer than 24 hours and/or preferably shorter than 72 hours. Even more preferably, the particles are annealed under an atmosphere containing at least 20% by volume of oxygen, preferably under air, preferably at atmospheric pressure.

The molten particles may be ground and/or may undergo a particle size selection operation according to the intended applications, for example by sieving, in particular so that the particles obtained have a size larger than 0.1 μm, or even larger than 1 μm, or even larger than 0.3 μm, or even larger than 0.5 μm, or even larger than 1 μm and/or smaller than 6 mm, or even smaller than 4 mm, or even smaller than 3 mm.

In a second version of the general method, the invention relates to a method for fabricating a block at least partially, or even fully, of a molten product according to the invention.

The invention relates in particular to a fabrication method, comprising steps a) and b) described above, in the context of the general fabrication method, and denoted, for this second version of the general method, “a₂)” and “b₂)”, respectively, and a step c) comprising the following steps:
c₂) pouring of said melting material into a mold;
d₂) solidification by cooling of the material poured into the mold until an at least partially solidified block is obtained;
e₂) stripping of the block.

In this second version of the general method, the fabrication method may also comprise one, or even more, of the general optional features listed below and/or the following particular optional features:
In step b₂), an induction furnace is used;
In step c₂) and/or step d₂) and/or after step e₂), said melting material in the course of pouring or in the course of solidification is placed in contact, directly or indirectly, with an oxygen-containing fluid, said oxygen-containing fluid preferably comprising at least 20%, or even at least 25%, by volume of oxygen, preferably with a gas, for example air;
Said contact is preferably started immediately after stripping the block;
Said contact is preferably maintained until complete solidification of the block;
The stripping of step e₂) is preferably carried out before complete solidification of the block;
The block is preferably stripped as soon as it has sufficient stiffness to substantially preserve its shape;
The rate of cooling of the melting material during the solidification is preferably always lower than 1000 K/s, preferably lower than 100 K/s, even more preferably lower than 50 K/s. In the case in which a cast iron or graphite mold is used, the cooling rate is preferably lower than 1 K/s;
After step e₂), the stripped block is annealed. Preferably, the block is annealed at a temperature of between 1050° C. and 1700° C., preferably between 1200° C. and 1650° C., preferably 1450° C. and 1650° C., for a temperature holding time, measured from the moment when the entire block has reached the holding temperature (at the surface of the block and the core of the block) preferably longer than 2 hours, preferably longer than 5 hours, preferably longer than 10 hours, preferably longer than 15 hours, preferably longer than 24 hours and/or preferably shorter than 72 hours. Even more preferably, the block is annealed under an atmosphere containing at least 20% by volume of oxygen, preferably under air, preferably at atmospheric pressure;
The stripped block, optionally annealed, is reduced to pieces or to powder.

The invention also relates to a product obtained by fusion, for example by a method according to the invention, comprising:
the element lanthanum (La),
optionally, an element (Ln) selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), and mixtures thereof,
optionally, the element cerium (Ce),
an element Qa selected from the group consisting of calcium (Ca), strontium (Sr), barium (Ba) and mixtures thereof,
the element manganese (Mn),
optionally an element Qb selected from the group consisting of magnesium (Mg), nickel (Ni), chromium (Cr), aluminum (Al), iron (Fe), cobalt (Co), titanium (Ti), tin (Sn), tantalum (Ta), indium (In), niobium (Nb) and mixtures thereof,
the element oxygen (O),
   the product having a chemical composition such that, by denoting
Laₚ the molar content of lanthanum;
Mnₚ the molar content of manganese;
Lnₚ the molar content of the element Ln;
Ceₚ the molar content of cerium;
Qaₚ the molar content of element Qa;
Qbₚ the molar content of element Qb;
   these contents being expressed as molar percentages on the basis of the total molar quantity of the elements La, Ln, Ce, Qa, Mn, Qb, and by setting
s=(Laₚ+Lnₚ+Ceₚ+Qaₚ)/(Mnₚ+Qbₚ),
z=Qbₚ/(Mnₚ+Qbₚ),
w=Lnₚ/(Laₚ+Lnₚ+Ceₚ+Qaₚ),
x=Ceₚ/(Laₚ+Lnₚ+Ceₚ+Qaₚ), and
y=Qaₚ/(Laₚ+Lnₚ+Ceₚ+Qaₚ),
   the composition of said product being such that
0≦w≦0.4, and
0≦x≦0.4, and
0.1≦y≦0.6, and
0<z≦0.5, and
0.8≦s≦1.25.

A product according to the invention is obtained, or can be obtained, by a method according to the invention.

A product according to the invention may comprise even one, or more, of the following optional features:
The elements La, Ln, Ce, Qa, Mn, Qb, and O account for, as weight percent, more than 95%, preferably more than 98.5%, preferably more than 99%, preferably more than 99.3%, or even more than 99.6% of the mass of product;
The product is an oxide;
The product is polycrystalline; the methods described above lead in particular to polycrystalline products;
The complement to 100% may consists of impurities;
Preferably, the impurities are all elements other than lanthanum, the element Ln, cerium, manganese, the element Qa, the element Qb, the element oxygen and the combinations thereof;
The molar content Oₚ of the element oxygen, as a molar percent on the basis of the total molar quantity of the elements La, Ln, Ce, Qa, Mn, Qb, O, such that 2/(3+s)≦Oₚ, or even 2.5/(3.5+s)≦Oₚ, or even 2.7/(3.7+s)≦Oₚ, or even 2.8/(3.8+s)≦Oₚ, or even 2.85/(3.85+s)≦Oₚ and/or Oₚ≦4/(5+s), or even Oₚ≦3.5/(4.5+s), or even Oₚ≦3.3/(4.3+s), or even Oₚ≦3.2/(4.2+s), or even Oₚ≦3.15/(4.15+s), or even Oₚ=3/(4+s);
In one embodiment, z>0;
In another embodiment, z=0 and:
   1.1<s≦1.25 or
   0.8≦s≦1.1 and
      w is different from 0 and Ln is not Yb and/or Y or
      w is different from 0 and Ln is equal to Yb and/or Y and x+y+w>0.6875 or
      w=0 and (x+y).s>0.55;
The molten product is not the product described in WO2008050063.
The weight content of impurities may be lower than 1.5%, preferably lower than 1%, preferably lower than 0.7%, preferably even lower than 0.4%. Even more preferably,
   SiO₂<0.1%, preferably SiO₂<0.07%, preferably SiO₂<0.06%, and/or
   ZrO₂<0.5%, preferably ZrO₂<0.1%, preferably ZrO₂<0.05%, and/or
   Na₂O<0.1%, preferably Na₂O<0.07%, preferably Na₂O<0.05%;
Preferably, the product according to the invention has, not including impurities, a perovskite content of LaLnCeQaMnQb higher than 30%, preferably higher than 50%, preferably higher than 70%, preferably higher than 85%, preferably higher than 90%, preferably even higher than 95%, or even higher than 96%, even more preferably higher than 99%, preferably still higher than 99.9%, or even substantially 100%;
A product according to the invention may have the form of a block having a thickness more than 1 mm, preferably more than 2 mm, preferably more than 5 cm, preferably even more than 15 cm, the thickness of a block being its smallest dimension. Preferably, this block has a mass higher than 200 g;
A product according to the invention may also be in the form of a particle, preferably having a size higher than 0.1 μm, or even higher than 1 μm, or even higher than 0.3 μm, or even higher than 0.5 μm, or even higher than 1 μm and/or lower than 6 mm, or even lower than 4 mm, or even lower than 3 mm. The sphericity of the particle may be higher than 0.5, preferably 0.6, the sphericity being defined as the ratio of its smallest dimension to its largest dimension;
A product according to the invention may also be in the form of a layer or of a coating applied to a substrate;
A product according to the invention may not have undergone annealing heat treatment after solidification or cooling and/or may not result from grinding;
A product according to the invention may also have the form of a powder, optionally obtained after grinding. The mean size of the particles may in particular be higher than 0.1 μm, or even higher than 0.3 μm, or even higher than 0.5 μm, or even higher than 1 μm, or even higher than 10 μm, and/or lower than 4 mm, or even lower than 3 mm. This powder may in particular comprise more than 90% by weight, or even more than 95% by weight, or even substantially 100% by weight of particles of the molten product according to the invention.

In a first alternative of the product, the element Qa is selected from the group consisting of calcium (Ca), strontium (Sr), barium (Ba) and mixtures thereof, preferably calcium (Ca); the element Qb is selected from the group consisting of magnesium (Mg), nickel (Ni), chromium (Cr), aluminum (Al), iron (Fe), cobalt (Co), titanium (Ti), tin (Sn), tantalum (Ta), indium (In), niobium (Nb) and mixtures thereof and
0.05≦x≦0.25, preferably 0.1≦x≦0.2 and
0.1≦x+y≦0.7, preferably 0.4≦x+y≦0.7, and
0≦z≦0.5, and
0.8≦s≦1.25, preferably 0.85≦s≦1.15, preferably 0.9≦s≦1.1, preferably 0.9≦s≦1, preferably 0.95≦s≦1.

In a first particular embodiment of the first alternative of the product of the invention:
0<z≦0.5, and
0.05≦x≦0.25, preferably 0.1≦x≦0.2 and
0.1≦x+y≦0.7, preferably 0.4≦x+y≦0.7, and
0.8≦s≦1.25, preferably 0.85≦s≦1.15, preferably 0.9≦s≦1.1, preferably 0.9≦s≦1, preferably 0.95≦s≦1.

In a second particular embodiment of the first alternative of the product of the invention:
z=0, and
0.05≦0.25, preferably 0.1≦x≦0.2 and
0.1≦x+y≦0.7, preferably 0.4≦x+y≦0.7, and
0.80≦s<0.9

In a third particular embodiment of the first alternative of the product of the invention:
z=0, and
0.05≦x≦0.25, preferably 0.1≦x≦0.2 and
0.5<x+y≦0.7, and
0.8≦s≦1.25, preferably 0.85≦s≦1.15, preferably 0.9≦s≦1,1, preferably 0.9≦s≦1, preferably 0.95≦s≦1.

For example, according to the first alternative,
Qa is Ca, and
z=0, and
x=0.2, and
y=0.5, and
s=1

In a second alternative of the product, the element Qa is calcium (Ca), the element Qb is chromium (Cr), and
0.18≦y≦0.4, and
0.05≦z≦0.15, and
0.8≦s≦1.25, preferably 0.85≦s≦1.15, preferably 0.9≦s≦1.1, preferably 0.9≦s≦1, preferably 0.95≦s≦1.

For example, according to the second alternative,
z=0.125 and
y=0.222, and
s=0.9.

In a third alternative of the product, the element Qa is selected from the group consisting of calcium (Ca), strontium (Sr), and mixtures thereof, and
0.01≦x≦0.047, and
0.155≦y≦0.39, and
0.80≦s≦1.25, preferably 0.85≦s≦1.15, preferably 0.90≦s≦1.1, preferably 0.9≦s≦1, preferably 0.95≦s≦1, even more preferably 0.96≦s≦0.995.

In a first particular embodiment of the third alternative of the product of the invention: 0.80≦s≦0.9.

In a fourth alternative of the product, the element Qa is selected from the group consisting of calcium (Ca), strontium (Sr), and mixtures thereof; the element Qb is selected from the group consisting of nickel (Ni), chromium (Cr), and mixtures thereof, and
0≦x≦0.205, and
0.15≦y≦0.25, preferably y=0.2, and
0.03≦z≦0.2, and
0.8≦s≦1.25, preferably 0.85≦s≦1.15, preferably 0.9≦s≦1.1, preferably 0.9≦s≦1, preferably 0.95≦s≦1.

For example, according to the fourth alternative:
Qa is Ca, and
Qb is Ni, and
z=0.125, and
x=0.1, and
y=0.2, and
s=1.

Also for example:
o Qa is Ca, and
Qb is a molar mixture of ⅔ Cr and ⅓ Ni, and
z=0.06 and
x=0.105, and
y=0.199, and
s=1.005.

Still for example:
Qa is Ca, and
Qb is a molar mixture of ½ Cr and ½ Ni, and
z=0.125 and
x=0.1, and
y=0.2, and
s=1

In a fifth alternative of the product, the element Ln is selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and mixtures thereof; preferably chosen from the group consisting of praseodymium (Pr), neodymium (Nd), samarium (Sm), and mixtures thereof; the element Qa is selected from the group consisting of calcium (Ca), strontium (Sr), barium (Ba), and mixtures thereof; the element Qa is preferably calcium; the element Qb is selected from the group consisting of magnesium (Mg), nickel (Ni), chromium (Cr), aluminum (Al), iron (Fe), and mixtures thereof, preferably from the group consisting of nickel (Ni), magnesium (Mg) and mixtures thereof, and
0.05≦w≦0.4, preferably 0.05≦w≦0.3, even more preferably 0.05≦w≦0.2 and
0≦x≦0.4, preferably 0≦x≦0.3, even more preferably 0≦x≦0.2 and
0.1≦y≦0.2, and
0.05≦z≦0.1, and
0.8≦s≦1.25, preferably 0.85≦s≦1.15, preferably 0.9≦s≦1.1, preferably 0.9≦s≦1, preferably 0.95≦s≦1.

In a sixth alternative of the product, the element Ln is selected from the group consisting of neodymium (Nd), samarium (Sm), gadolinium (Gd), dysprosium (Dy), erbium (Er), yttrium (Y), and mixtures thereof, preferably the element Ln consists of an element selected from the group consisting of samarium (Sm), gadolinium (Gd), dysprosium (Dy), erbium (Er), and mixtures thereof, preferably the element Ln consists of at least samarium (Sm), preferably the element Ln is selected from the group consisting of samarium (Sm), gadolinium (Gd), dysprosium (Dy), erbium (Er), and mixtures thereof, preferably the element Ln is samarium (Sm); the element Qa is calcium (Ca), and
0.005≦w≦0.4, preferably 0.175≦w≦0.185, and
0.005≦x≦0.02, and
0.1≦y≦0.6, preferably 0.255≦y≦0.265, and
0.8≦s≦1.25, preferably 0.85≦s≦1.15, preferably 0.9≦s≦1.1, preferably 1≦s≦1.02, even more preferably 1.001≦s≦1.01, and
preferably 0.55≦1-w-x-y≦0.56.

For example, according to the sixth alternative:
Qa is Ca, and
Ln is selected from the group consisting of neodymium (Nd), samarium (Sm), gadolinium (Gd), dysprosium (Dy), erbium (Er), yttrium (Y), and mixtures thereof, for example also Ln is Sm or Gd or Dy.
w=0.179, and
x=0.01, and
y=0.259, and
s=1.005.

In a seventh alternative, the element Qa is calcium (Ca), and
0.1≦x≦0.2, and
0.2≦y≦0.55, and
0.8≦1.25, preferably 0.85≦s≦1.15, preferably 0.9≦s≦1.1, preferably 0.9≦s≦1, preferably 0.95≦s≦1.

According to a first particular embodiment of the seventh alternative of the product of the invention:
0.1≦x≦0.2, and
0.5<x+y≦0.75, and
0.8≦s≦1.25, preferably 0.85≦s≦1.15, preferably 0.9≦s≦1.1, preferably 0.9≦s≦1, preferably 0.95≦s≦1.

The invention also relates to the use of a product according to the invention, particularly a product fabricated or suitable for fabrication by a method according to the invention, in the fabrication of cathodes for solid oxide fuel cells (SOFC). The invention also relates to a cathode for solid oxide fuel cells comprising, or even consisting of, a product according to the invention, fabricated in particular by a method according to the invention.

### DEFINITIONS

Conventionally, “perovskite” means any element having a structure of the ABO_{3-δ} type. Said perovskite, having the A sites and the B sites, being electrically neutral, the value δ corresponds to the value required to ensure its electroneutrality. When products fabricated from a method according to the invention consist of a perovskite phase, their composition can be expressed in the following form:

(La_{1-w-x-y)}Ln_{w}CeₓQa_{y})ₛ(Mn_{(1-z)}Qb_{z})O_{3-δ}.

The values s, w, x, y, and z then preferably satisfy the above-mentioned conditions.

Conventionally, the above formula means that the elements La, Ln, Ce and Qa are at the A sites, and that the elements Mn and Qb are at the B sites.

For the sake of clarity, this perovskite is called “perovskite of LaLnCeQaMnQb” here.

The proportion of perovskite of LaLnCeQaMnQb not including impurities, is defined in %, by the following formula (1):

T=100*(A_{LaLnCeQaMnQb})/(A_{LaLnCeQaMnQb}+A_{Other phases}) (1)
A_{LaLnCeQaMnQb} is the area measured on an X-ray diffraction diagram obtained using an apparatus of the Bruker D5000 diffractometer type provided with a copper DX tube, without deconvolution treatment, of the main peak or of the main diffraction multiplet due to the presence of phases of perovskite consisting of La, Mn and O, and optionally at least one of the elements Ln, Ce, Qa and Qb; the inventors consider that this main peak or this main multiplet corresponds to the LaLnCeQaMnQb perovskite phase; in the present description, the term “perovskite of LaLnCeQaMnQb” therefore refers to the phase corresponding to this main peak or this main multiplet;
A_{Other phases} is the sum of the areas measured on the same diagram, without deconvolution treatment, of each main peak or main diffraction multiplet of each phase different from the LaLnCeQaMnQb perovskite phase (the latter being measured by the main peak or the main diffraction multiplet due to the presence of perovskite phases consisting of La, Mn and O, and optionally at least one of the elements Ln, Ce, Qa et Qb). Inter alia, the CeO₂ phase or a doped CeO₂ phase may, for example, be one of the other phases identified in the X-ray diffraction diagram.

A multiplet is the partial superimposition of a plurality of peaks. For example, a multiplet comprising two peaks is a doublet, a multiplet comprising three peaks is a triplet.

In general, the expression “molten product” or “obtained by fusion” means a solid product, optionally annealed, obtained by complete solidification, by cooling, of a bath of melting material. The “stripped” product obtained at the end of step e₂) may still comprise unsolidified zones and, immediately after stripping, it is therefore not considered as a molten product.

A “bath” of melting material is a mass which, to preserve its shape, must be contained in a receptacle. A bath of melting material, apparently liquid, may contain solid portions, but in insufficient quantity for them to structure said mass.

The term “size” of a particle is the mean of its largest dimension dM and its smallest dimension dm: (dM+dm)/2.

The thickness of a block is its smallest dimension.

The term “impurities” means inevitable constituents, necessarily introduced with the raw materials or resulting from reactions with these constituents.

### BRIEF DESCRIPTION OF THE FIGURE

FIG. 1 shows an X-ray diffraction diagram of the product of example 1 described below. The X-axis represents the angular domain 2θ considered.

### DETAILED DESCRIPTION OF A METHOD ACCORDING TO THE FIRST VERSION OF THE GENERAL method

A method according to the first version of the general method of the invention is now described in detail.

In step a₁), a starting charge serving to fabricate a particle according to the invention is formed from compounds of lanthanum, manganese, the element Qa, cerium, the element Qb and the element Ln, particularly in the form of precursors of these various elements, in particular in the form of oxides, carbonates, nitrates, hydrates, oxalates. The compositions can be adjusted by the addition of pure oxides or mixtures of oxides and/or precursors. The use of oxides and/or carbonates and/or hydrates and/or nitrates improves the availability of oxygen required for the formation of perovskite and is therefore preferred.

The quantities of lanthanum, manganese, element Qa, cerium, element Qb and element Ln of the starting charge are essentially found in the molten product fabricated. Part of these constituents, which varies according to the fusion conditions, may be volatilized during the fusion step. From his general knowledge, or from simple routine tests, a person skilled in the art knows how to adjust the quantity of these constituents in the starting charge according to the content that he wishes to find in the molten products and the fusion conditions applied.

The particle size distributions of the powders used may be those commonly encountered in fusion methods.

The basic mixture may comprise, in addition to compounds providing lanthanum, manganese, the element Qa, cerium, the element Qb and the element Ln and the impurities, other compounds introduced to impart a particular property to the fabricated particles.

However, preferably, no compound other than those providing the elements lanthanum, manganese, element Qa, cerium, element Qb and element Ln is voluntarily introduced into the starting charge, the other elements present being impurities.

Preferably, the compounds providing the elements lanthanum and manganese are selected from La₂O₃, MnO₂, MnO, Mn₃O₄. Similarly, the compounds providing the elements cerium, calcium, magnesium and strontium are preferably selected from CeO₂, cerium carbonate (Ce₂(CO₃)₃.vH₂O), cerium oxalate, (Ce₂(C₂O₄)₃.vH₂O), CaO, CaCO₃, Ca(NO₃)₂, MgO, MgCO₃, Mg(NO₃)₂, SrO, SrCO₃, Sr(NO₃)_{2.}

To increase the proportion of LaLnCeQaMnQb perovskite, it is preferable for the molar contents of the elements La, Ln, Ce, Qa, Mn and Qb in the starting charge to be close to those of the perovskite that is to be fabricated.

Thus, it is preferable, in the starting charge, for the molar contents Laₚ, Lnₚ, Ceₚ, Qaₚ, Mnₚ, Qbₚ of the lanthanum Ln, cerium, Qa, manganese, and Qb respectively, in molar percentages on the basis of the total molar quantity of the elements La, Ln, Ce, Qa, Mn, Qb, to satisfy the following conditions:
k₁. w/x≦Lnₚ/Ceₚ≦k₂. w/x and/or
k₁. w/y≦Lnₚ/Qaₚ≦k₂. w/y and/or
k₁. x. s/z≦Ceₚ/Qbₚ≦k₂. x. s/z, and/or
k₁. w.s/z≦Lnₚ/Qbₚ≦k₂. w.s/z and/or
k₁. y.s/z≦Qaₚ/Qbₚ≦k₂. y.s/z and/or
k₁. (1-w-x-y)/w≦Laₚ/Lnₚ≦k₂. (1-w-x-y)/w and/or
k₁. (1-z)/z≦Mnₚ/Qbₚ≦k₂. (1-z)/z,
   to preferably satisfy the following conditions:
k₁. w/x≦Lnₚ/Ceₚ≦k₂. w/x and
k₁. w/y≦Lnₚ/Qaₚ≦k₂. w/y and
k₁. x. s/z≦Ceₚ/Qbₚ≦k₂. x. s/z and
k₁. w.s/z≦Lnₚ/Qbₚ≦k₂. w.s/z and
k₁. y.s/z≦Qaₚ/Qbₚ≦k₂. y.s/z and
(1-w-x-y)/w≦Laₚ/Lnₚ≦k₂. (1-w-x-y)/w and
k₁. (1-z)/z≦Mn/Qbₚ≦k₂. (1-z)/z,
   where
w, x, y, z and s may have the values defined above, in particular
   0≦w≦0.4, and
   0≦x≦0.4, and
   0.1≦y≦0.6, and
   0≦z≦0.5, and
   0.8≦s≦1.25,
k₁ is equal to 07, preferably to 0.8, preferably to 0.9, and
k₂ is equal to 1.3, preferably to 1.2, preferably to 1.1.

Obviously, these values of k₁ and k₂ are those to be adopted under the steady state operating conditions, that is, outside transition phases between different components and outside the starting phases. In fact, if the desired product implies a change in composition of the starting charge compared to that used to fabricate the preceding product, the residues of the preceding product in the furnace must be taken into account. However, a person skilled in the art knows how to adjust the starting charge accordingly.

In one embodiment, 0.95≦s≦1 in order to limit the formation of lanthanum hydroxides.

An intimate mixture of the raw materials can be prepared in a mixer. This mixture is then poured into a melting furnace.

In step b₁), the starting charge is melted, preferably in an electric arc furnace. Electrofusion is in fact suitable for fabricating large quantities of particles with advantageous yields.

An electric arc furnace of the Heroult type can be used for example, comprising two electrodes, with a tank about 0.8 m diameter and capable of containing about 180 kg of melting material. Preferably, the voltage is between 140 and 180 volts, the wattage about 240 kW and the power supply between 1150 to 2800 kWh/T.

However, all known furnaces can be used, such as an induction furnace, a plasma furnace or other types of Heroult furnace, provided that they allow the melting of the starting charge. Without this being systematic, it is possible to increase the quality of mixing by bubbling an oxidizing gas (air or oxygen for example) as mentioned in FR 1 208 577. The mixing quality of the melting material can be improved in particular by bubbling a gas containing 35% by volume of oxygen.

At the end of step b₁), the whole starting charge is in the form of a bath of melting material.

In step c₁), a stream of melting material, preferably at a temperature above 1500° C. and, preferably lower than 2200° C., is dispersed in small liquid droplets.

The dispersion may result from blowing across the stream of melting material. However, any other method for spraying a melting material, known to a person skilled in the art, is feasible.

In step d₁), the liquid droplets are converted to solid particles by contact with an oxygen-containing fluid, preferably gaseous, even more preferably with air and/or water vapor. The oxygen-containing fluid preferably comprises at least 20%, or even at least 25%, by volume of oxygen.

Preferably, the method is adapted so that, as soon as it is formed, the droplet of melting material is in contact with the oxygen-containing fluid. Even more preferably, the dispersion (step c₁)) and solidification (step d₁)) are substantially simultaneous, the melting material being dispersed by an oxygen-containing fluid capable of cooling and solidifying this material.

Preferably, the contact with the oxygen-containing fluid is maintained at least until complete solidification of the particles.

Preferably, no other means of solidification than cooling by contact with the oxygen-containing fluid is used. Thus for example, preferably, the hyper quench method involving the spraying of droplets of melting material on a cooled metal wall is not used.

Air blowing at ambient temperature is suitable.

The cooling rate depends on the diameter of the particles. Preferably, the cooling rate is adjusted so that the particles are hardened, at least at the periphery, before entering into contact with the recovery container.

At the end of step d₁), solid particles according to the invention are obtained, having a size of between 0.1 μm and 3 mm, or even between 0.1 μm and 4 mm, according to the dispersion conditions.

Advantageously, surprisingly, and inexplicably, the contacting of the melting material with an oxygen-containing fluid serves to obtain, in industrial quantities and at reduced cost, products having a proportion of LaLnCeQaMnQb perovskite, not including impurities, that is advantageous, reaching more than 85%, more than 90%, more than 95%, and even more than 96%, without an annealing step.

In an optional subsequent step e₁), the molten particles are introduced into a furnace to undergo annealing heat treatment. Advantageously, this annealing serves to further increase the proportion of LaLnCeQaMnQb perovskite. A proportion of LaLnCeQaMnQb perovskite higher than 90% is thereby obtained, or even higher than 95%, or even higher than 96%, or even higher than 99%, or even higher than 99.9%, or even substantially equal to 100%, not including impurities.

The annealing temperature is preferably between 1050° C. and 1700° C., preferably between 1200° C. and 1650° C., preferably between 1450° C. and 1650° C., for a temperature holding time that is preferably longer than 2 hours, preferably longer than 5 hours, preferably, longer than 10 hours, preferably longer than 15 hours, preferably longer than 24 hours and/or preferably shorter than 72 hours. Even more preferably, the particles are annealed under an atmosphere containing at least 20% by volume of oxygen, preferably under air, preferably at atmospheric pressure.

The molten particles according to the invention may be ground, before or after annealing. If necessary, a particle size selection is then performed, according to the intended application.

The particles according to the invention may advantageously have various dimensions, the fabrication method not being limited to obtaining submicron-scale powders. It is therefore perfectly suitable for industrial fabrication.

Furthermore, the particles obtained comprise LaLnCeQaMnQb perovskite. In certain conditions, for example after annealing, they have enough of said perovskite to be usable to fabricate a cathode for solid oxide fuel cells (SOFC).

Other phases than LaLnCeQaMnQb perovskite may however be present, and also impurities from the raw materials.

The following examples are provided for illustration and do not limit the invention. The tested particles were fabricated as follows.

The following starting raw materials were first mixed intimately in a mixer:
La₂O₃ powder, sold by TREIBACHER having a purity above 99% by weight and a mean size smaller than 45 μm;
CaO powder, sold by LA GLORIETTE, having a purity higher than 93% by weight, and an 80 μm mesh undersize of more than 90%;
MnO₂ powder, sold by DELTA, having a purity higher than 91% by weight and a mean size of about 45 μm;
CeO₂ powder, sold by ALTICHEM, having a purity higher than 99% by weight and a maximum size smaller than 20 μm;
MgO powder, sold by DELTAMAT PAQUET, having a purity higher than 99% by weight and a maximum size smaller than 1 mm;
Gd₂O₃ powder, sold by TREIBACHER, having a purity higher than 99.99% by weight and a mean size of between 2 and 10 μm.

The starting charge thus obtained, having a mass of 50 kg, was poured into a Heroult type arc melting furnace. It was then melted by long arc fusion (voltage 150 volts, wattage 225 kW, energy applied 1400 kWh/T) in order to melt the entire mixture completely and uniformly. The processing conditions were oxidizing.

When the melting was complete, the melting material was poured in order to form a stream. The temperature of the melting material measured during the pouring was between 1565 and 1640° C.

The blowing of compressed dry air, at ambient temperature and at a pressure of between 1 and 4 bar, breaks the stream and disperses the melting material in droplets.

The blowing cools these droplets and fixes them in the form of melted particles. According to the blowing conditions, the melted particles may be spherical or not, hollow or solid. They have a size of between 0.1 mm and 3 mm, or even between 0.1 and 4 mm.

The chemical analyses and the determination of the LaLnCeQaMnQb perovskite phase were carried out on samples which, after grinding, had a mean size smaller than 40 μm.

The chemical analysis was carried out by X-ray fluorescence.

The determination of the proportion of LaLnCeQaMnQb perovskite was carried out from the X-ray diffraction diagrams, obtained with a Bruker D5000 diffractometer provided with a copper DX tube. After melting, the products obtained may comprise LaLnCeQaMnQb perovskite phases and also other phases, such as CeO₂, or CeO₂ doped for example with calcium.

In practice, the measurements of the proportion of LaLnCeQaMnQb perovskite are carried out when the X-ray diffraction diagram shows:
a phase of LaLnCeQaMnQb perovskite,
other phases.

Then, using the EVA software (sold by Bruker) and after having subtracted the background (background 0.8), it is possible to measure the area A_{LaLnCeQaMnQb} (without deconvolution treatment) of the main peak or main diffraction multiplet of LaLnCeQaMnQb perovskite and the area A_{other phases} (without deconvolution treatment) of the main peaks or main diffraction multiplets of the other phases. The proportion of LaLnCeQaMnQb perovskite is then calculated by formula (I).

Thus, if the lanthanum perovskite phase LaLnCeQaMnQb is the only phase present in the X-ray diffraction diagram, the proportion of perovskite is 100%.

For example, the calculation of the proportion of LaLnCeQaMnQb perovskite of the product in example 1 is made as follows:

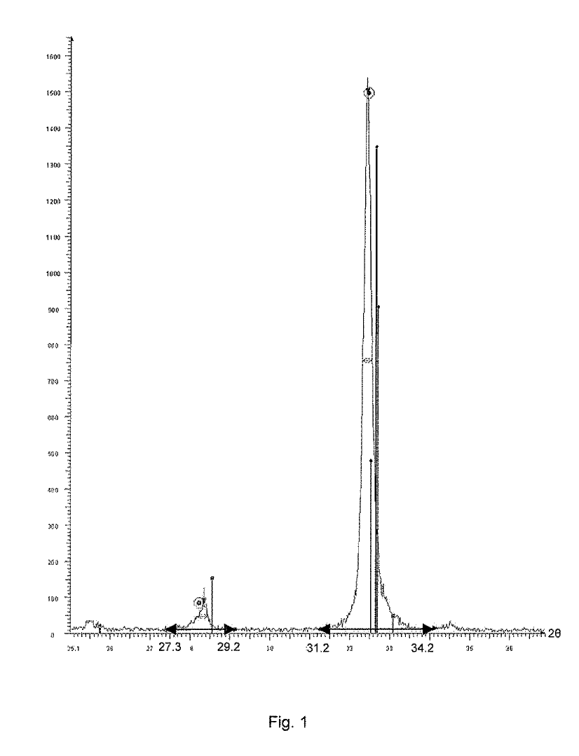

The X-ray diffraction diagram of the product of example 1, given in FIG. 1, shows:
a main peak of LaCeCaMnMg perovskite in the angular domain 2θ of between 31.2° and 34.2°, with a measured area of 265;
a main peak of doped CeO₂ in the angular domain 2θ of between 27.3° and 29.2°, having a measured area of 11.2.

The proportion of LaCeCaMnMg perovskite of the product in example 1 is calculated by formula (I): 100·(265/(265+11.2))=95.9%

Table 1 shows the results obtained before any annealing heat treatment.

TABLE 1

| | | | Chemical analysis obtained (wt %) | | | | | | | | | | | | |
|---|---|---|---|---|---|---|---|---|---|---|---|---|---|---|---|
| | | Energy | | | | | | | Impurities | | | | | | Proportion of |
| | Voltage | applied | | | | | | | expressed in | | | | | | LaLnCeQaMnQb |
| Example | (Volts) | (kWh/T) | La | Gd | Ce | Ca | Mn | Mg | oxide form | w | x | y | z | s | perovskite (%) |
| 1 | 150 | 1400 | 42.9 | — | 6.76 | 3.53 | 22.6 | 0.98 | 0.7 | 0 | 0.11 | 0.2 | 0.09 | 0.99 | 95.9 |
| 2 | 150 | 1400 | 42.1 | — | 7.78 | 3.74 | 21.4 | 1.72 | 0.8 | 0 | 0.12 | 0.21 | 0.15 | 0.98 | 94.2 |
| 3 | 150 | 1400 | 33.7 | — | 13.2 | 6.43 | 19.3 | 3.59 | 0.95 | 0 | 0.19 | 0.32 | 0.3 | 1 | 86.3 |
| 4 | 150 | 1400 | 28.5 | 5.7 | 14 | 6.34 | 18.4 | 3.56 | 0.9 | 0.07 | 0.2 | 0.32 | 0.3 | 1.04 | 84.1 |
| 5 | 150 | 1480 | 43.1 | — | 6.77 | 3.71 | 21.7 | 1.34 | 0.9 | 0 | 0.107 | 0.205 | 0.123 | 1 | 92.9 |

(La_{(1-w-x-y)} Ln_{w} Ceₓ Qa_{y})ₛ (Mn_{(1-z)} Qb_{z}) O_{3-δ}

Table 1 reveals the effectiveness of the inventive method.

A heat treatment was then carried out on the product of example 1 under the following conditions:

Temperature: 1600° C.

Holding time: 48 hours

Atmosphere: air, atmospheric pressure (ambient).

After heat treatment, the product has a proportion of LaCeCaMnMg perovskite of 99%, not including impurities.

As it now clearly appears, a method according to the first version of the general method of the invention serves to fabricate simply and economically, in industrial quantities, particles of a product based on lanthanum and manganese, and possibly also comprising large quantities of LaLnCeQaMnQb perovskite.

In particular, this method serves to fabricate particles consisting, not including impurities, of over 85%, or even more than 90%, or even more than 95%, or even more than 96%, or even more than 99%, or even more than 99.9%, or even more than 100%, of perovskite having the formula (La_{(1-w-x-y)}Ln_{w}CeₓQa_{y})ₛ(Mn_{(1-z)}Qb_{z})O_{3-δ}, with Ln selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), yttrium (Y), and mixtures thereof; Qa selected from the group consisting of calcium (Ca), strontium (Sr), barium (Ba), and mixtures thereof; Qb selected from the group consisting of magnesium (Mg), nickel (Ni), chromium (Cr), aluminum (Al), iron (Fe), cobalt (Co), titanium (Ti), tin (Sn), tantalum (Ta), indium (In), niobium (Nb), and mixtures thereof; and 0≦w≦0.4; 0≦x≦0.4; 0.1≦y≦0.6; 0≦z≦0.5; 0.8≦s≦1.25, δ serving to ensure the electroneutrality of said perovskite.

The dimensions of these particles can then be reduced, for example by grinding, to the form of finer powders if required by their intended use.

### DETAILED DESCRIPTION OF A METHOD ACCORDING TO THE SECOND VERSION OF THE GENERAL method

A method according to the second version of the general method of the invention is now described in detail.

In step a₂), a starting charge is prepared as stated in step a₁) described above, the step a₂) having the same preferred features as the step a₁).

In step b₂), the starting charge is melted, preferably in an electric arc furnace or in an induction furnace.

An electric arc furnace of the Heroult type can be used for example, comprising two electrodes, with a tank about 0.8 m diameter and capable of containing about 180 kg of melting material. Preferably, the voltage is between 140 and 180 volts, the wattage about 240 kW and the power supply between 1150 to 2800 kWh/T.

However, all known furnaces can be used, such as a plasma furnace or other types of Heroult furnace, provided that they allow the melting of the starting charge. Without this being systematic, it is possible to increase the quality of mixing by bubbling an oxidizing gas (air or oxygen for example) as mentioned in FR 1 208 577. The mixing quality of the melting material can be improved in particular by bubbling a gas containing 35% by volume of oxygen.

Even more preferably, the induction furnace is preferred among all, as for example described in FR 1 430 962. Advantageously, the block can thus be stripped before complete solidification, the core of the block still being liquid.

At the end of step b₂), the entire starting charge is in the form of a bath of melting material.

In step c₂), the melting material is poured into a mold. The poured melting material has a temperature preferably above 1500° C. and, preferably lower than 2200° C. Preferably, use is made of graphite, cast iron molds, or such as defined in U.S. Pat. No. 3,993,119. In the case of an induction furnace, the coil is considered as constituting a mold. Pouring is preferably carried out in air.

In step d₂), the material poured into the mold is cooled until an at least partially solidified block is obtained.

Preferably, during solidification, the melting material is placed in contact with an oxygen-containing fluid, preferably gaseous, preferably with air. This contacting can be carried out from the time of pouring. However, it is preferable to start this contacting only after pouring. For practical reasons, the contacting with the oxygen-containing fluid only begins preferably after stripping, preferably as early as possible after stripping.

The oxygen-containing fluid preferably comprises at least 20%, or even at least 25%, by volume of oxygen.

Preferably, the contact with the oxygen-containing fluid is maintained until the complete solidification of the block. This contact may be direct, for example for surfaces of the melting material poured into the mold forming the interface with the surrounding air. It may also be indirect, for example for the material still melting in the core of a block of which the outer surfaces have already solidified. The oxygen must then cross the “walls” thereby produced to reach the melting material.

Said contacting of the melting material during solidification with an oxygen-containing fluid preferably begins less than one hour, preferably less than 30 minutes, even more preferably less than 20 minutes after the start of solidification.

Advantageously, surprisingly and inexplicably, the contacting of the melting material with an oxygen-containing fluid can advantageously increase the proportion of LaLnCeQaMnQb perovskite in the molten block according to the invention.

Furthermore, the inventors have discovered that the cooling rate during solidification is not determining for improving the proportion of LaLnCeQaMnQb perovskite. Preferably, the cooling rate is therefore always kept lower than 1000 K/s, preferably lower than 100 K/s, preferably lower than 50 K/s. Advantageously, simple conventional cooling means can thus be employed. Preferably, to solidify the melting material, that is to fix it, use is only made of molds in contact with the surrounding air or cooled, particularly by circulation of a heat transfer fluid, or when the block is extracted from the mold and still contains melting material, or contact of this block with the oxygen-containing fluid. The reliability and costs are thereby improved.

In step e₂), the block is stripped. To facilitate the contacting of the melting material with an oxygen-containing fluid, it is preferable to strip the block as quickly as possible, if possible before complete solidification. The solidification therefore continues in step e₂).

Preferably, the block is stripped as soon as it shows a sufficient stiffness to substantially preserve its shape. Preferably, the block is stripped as quickly as possible and the contacting with the oxygen-containing fluid is immediately begun.

Preferably, the stripping is carried out less than 20 minutes after the start of solidification.

After complete solidification, a block according to the invention is obtained, containing commensurately more LaLnCeQaMnQb perovskite as the melting material has been kept in contact with oxygen in an early step of the solidification.

In an optional step f₂) the stripped block is charged in a furnace to undergo annealing heat treatment. Advantageously, this annealing serves to substantially increase the proportion of LaLnCeQaMnQb perovskite. Proportions of LaLnCeQaMnQb perovskite higher than 85% are thereby obtained, preferably higher than 90%, preferably higher than 95%, preferably higher than 96%, preferably higher than 99%, preferably higher than 99,9%, or even 100%, not including impurities.

Starting with a proportion of LaLnCeQaMnQb perovskite, not including impurities, of 99.9%, the composition and structure of the LaLnCeQaMnQb perovskite can be expressed by the formula (La_{(1-w-x-y)}Ln_{w}CeₓQa_{y})ₛ(Mn_{(1-z)}Qb_{z})O_{3δ}, with Ln selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), de yttrium (Y), and mixtures thereof; Qa selected from the group consisting of calcium (Ca), strontium (Sr), barium (Ba), and mixtures thereof; Qb selected from the group consisting of magnesium (Mg), le (Ni), chrome (Cr), aluminum (Al), iron (Fe), cobalt (Co), titanium (Ti), tin (Sn), tantalum (Ta), indium (In), niobium (Nb) and mixtures thereof; and 0≦w≦0.4; 0≦x≦0.4; 0.1≦y≦0.6; 0≦z≦0.5; 0.8≦s≦1.25, where δ serves to ensure the electroneutrality of said perovskite.

Advantageously, the annealing heat treatment increases the proportion of LaLnCeQaMnQb perovskite, even if no melting material has been contacted with an oxygen-containing fluid, for example because the fabricated block was already completely solidified at the time of stripping and no contacting with an oxygen-containing fluid was feasible during the cooling in the mold or during the pouring.

The parameters of the annealing heat treatment depend on the dimensions of the blocks treated. Preferably, these parameters are as follows:
Annealing temperature: between 1050° C. and 1700° C., and preferably between 1200° C. and 1650° C., and preferably between 1450° C. and 1650° C.
Holding time: preferably longer than 2 hours, preferably longer than 5 hours, preferably longer than 10 hours, preferably longer than 15 hours, preferably longer than 24 hours, and/or preferably shorter than 72 hours, from the time when the entire block has reached the holding temperature (at the surface of the block and in the core of the block). By way of example, for blocks of which all the dimensions are smaller than 5 mm, the holding time is preferably 5 hours. For a cylindrical block with a diameter of 200 mm and a height of 150 mm, the holding time is preferably 15 hours.

In all cases, preferably, the annealing heat treatment is carried out under an atmosphere containing at least 20% by volume of oxygen, preferably under air, preferably at atmospheric pressure of 1 bar.

The annealing heat treatment must be carried out after complete solidification of the block. Before being annealed, the block may however be reduced to pieces or powder. Preferably, the block is ground in the form of particles having a size of 5 mm or smaller than 5 mm.

The method described above yields a block according to the invention.

The block according to the invention may advantageously have any dimensions.

It is therefore perfectly suitable for industrial fabrication. Preferably, the block has a thickness above 1 mm, preferably above 2 mm, preferably above 5 cm, even more preferably above 15 cm, the thickness of a block being its smallest dimension.

To obtain a powder, for example to fabricate a cathode for solid oxide fuel cells (SOFC), the block, optionally annealed, is then crushed and ground to the desired particle size distribution. Advantageously, the inventive method allows the fabrication of particles of various dimensions at reduced cost.

Preferably, the stripped block is first crushed into pieces of 0 to 5 mm. An annealing heat treatment is then carried out on these pieces, which are then ground to the desired particle size distribution.

A method according to the second version of the general method of the invention serves to simply and economically fabricate, in industrial quantities, blocks of the product according to the invention. In particular, this method serves to fabricate blocks consisting, not including impurities, of more than 85%, or even more than 90%, or even more than 95%, or even more than 99%, or even more than 99.9%, or even substantially 100%, of LaLnCeQaMnQb perovskite having the formula (La_{(1-w-x-y)}Ln_{w}CeₓQa_{y})ₛ(Mn_{(1-z)}Qb_{z})O_{3-δ}, with Ln selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), de yttrium (Y), and mixtures thereof; Qa selected from the group consisting of calcium (Ca), strontium (Sr), barium (Ba), and mixtures thereof; Qb selected from the group consisting of magnesium (Mg), nickel (Ni), chrome (Cr), aluminum (Al), iron (Fe), cobalt (Co), titanium (Ti), tin (Sn), tantalum (Ta), indium (In), niobium (Nb) and mixtures thereof; and 0≦w≦0.4; 0≦x≦0.4; 0.1≦y≦0.6; 0≦z≦0.5; 0.8≦s≦1.25, where δ serves to ensure the electroneutrality of said perovskite.

The dimension of the blocks can then be reduced, for example by grinding in the form of powders if demanded by their intended use.

Obviously, the present invention is not limited to the embodiments described provided as illustrative examples and nonlimiting.

In particular, the products according to the invention are not limited to particular shapes or dimensions.

The invention is nevertheless limited to molten products.

The molten products of doped lanthanum-manganese perovskite (La_{(1-w-x-y)})Ln_{w}CeₓQa_{y})ₛ(Mn_{(1-z))}Qb_{z})O_{3-δ} are advantageous in particular because, in case of direct contact with doped zirconia, the quantities of the pyrochlore type phase La₂Zr₂O₇ and/or the phases of type QaₐZr_{b}O_{c} and/or La_{d}QaₑZr_{f}Qb_{g}Oₕ generated (a, b, c, d, f, h being strictly positive real numbers, and e and g being positive real numbers or zero satisfying the equation if e=0 then g≠0 and if g=0 then e≠0), measured according to the protocol described below, are systematically lower than those generated under the same conditions by a perovskite powder obtained by a method other than fusion, and particularly by a sintered powder. This property even appears to constitute a signature of the products according to the invention.

The method used to measure this property is as follows:

10 grams of (La_{(1-w-x-y)}Ln_{w}CeₓQa_{y})ₛ(Mn_{(1-z)}Qb_{z})O_{3-δ} perovskite powder to be tested, having a mean size smaller than 1.5 microns, is intimately mixed with the same quantity of a stabilized zirconium powder containing 8 mol % of yttrium oxide. Pellets of this mixture are then pressed and sintered at high temperature, in a cycle with a holding plateau of 24 hours at 1375° C. The mean size of the powders (La_{(1-w-x-y)}Ln_{w}CeₓQa_{y})ₛ(Mn_{(1-z)}Qb_{z})O_{3-δ} and the parameters during the sintering heat treatment were determined in order to promote the formation of a phase of the pyrochlore type La₂Zr₂O₇ and/or phases of the type QaₐZr_{b}O_{c} and/or of type La_{d}QaₑZr_{f}Qb_{g}Oₕ, and thereby identify the differences in behavior of the powders of (La_{(1-w-x-y)}Ln_{w}CeₓQa_{y})ₛ(Mn_{(1-z)}Qb_{z})O_{3-δ} in contact with a stabilized zirconium powder containing 8 mol % of yttrium oxide.

The quantities of the phase of pyrochlore type La₂Zr₂O₇ and/or phases of type QaₐZr_{b}O_{c} and/or type La_{d}QaₑZr_{f}Qb_{g}Oₕ contained in the sintered sample, each expressed with regard to the total quantity of phase of pyrochlore type La₂Zr₂O₇, phases of type QaₐZr_{b}O_{c}, phases of type La_{d}QaₑZr_{f}Qb_{g}Oₕ and of zirconia of this sample, are measured by X-ray diffraction. The measurements taken are therefore comparative measurements, and not quantitative measurements.

Comparisons between various powders of (La_{(1-w-x-y)}Ln_{w}CeₓQa_{y})ₛ(Mn_{(1-z)}Qb_{z}) O_{3-δ} perovskite are easy to make, taking care to use the same protocol, and also the same stabilized zirconia powder. Preferably, all the samples are sintered in the same furnace, with a concern to limit possible scatter induced by the method for preparing the samples to be characterized.

### EXAMPLES

The following tests were performed in order to illustrate the capacity of the molten perovskite product to generate less phase La₂Zr₂O₇ and/or phases QaₐZr_{b}O_{c} and/or of type La_{d}QaₑZr_{f}Qb_{g}Oₕ when they are in contact at high temperature with a stabilized zirconia powder.

They consist in intimately mixing a zirconia powder and a doped lanthanum-manganese perovskite powder (La_{(1-w-x-y)}Ln_{w}CeₓQa_{y})ₛ(Mn_{(1-z)}Qb_{z})O_{3-δ}, in shaping a pellet, and then in heating it to high temperature in order to favor the creation of the phase La₂Zr₂O₇ and/or of phases QaₐZr_{b}O_{c} and/or La_{d}QaₑZr_{f}Qb_{g}Oₕ. The quantity generated for each of these phases, related to the total quantity of phase of pyrochlore type La₂Zr₂O₇, phases of type QaₐZr_{b}O_{c}, phases of type La_{d}QaₑZr_{f}Qb_{g}Oₕ and of zirconia of the sample is then determined by X-ray diffraction.

In detail, the following methodology was carried out:

Samples comprising powders of (La_{(1-w-x-y)}Ln_{w}CeₓQa_{y})ₛ(Mn_{(1-z)}Qb_{z})O_{3-δ} for comparison were prepared as follows:

10 grams of zirconia TZ-8Y powder (stabilized zirconia containing 8 mol % of yttrium oxide and having a mean size d₅₀ of 0.212 μm (measured by sedigraphy), and a specific surface area of 15.2 m²/g) sold by TOSOH and 10 grams of one of the powders of (La_{(1-w-x-y)}Ln_{w}CeₓQa_{y})ₛ(Mn_{(1-z)}Qb_{z})O_{3-δ} perovskite to be compared, having a mean size of 0.25 μm after optional grinding, for example in a NETZSCH LME grinder (1) with stabilized zirconia beads containing 16.5 mol % of cerium oxide with a particle size distribution of 0.8-1 mm, are mixed using a stainless steel spatula in a glass beaker, until the color is uniform. The mixture is then transferred in small quantities to an agate mortar to be ground by hand using an agate pestle, and all the powder is then again mixed in the glass beaker with the stainless steel spatula.

Pellets having a diameter of 13 mm and substantially 5 mm thick are then prepared using a pelletizer: 2.8 grams of powder are introduced therein and pressed under 50 kN with a Weber manual press for 1 min.

The pellets are then placed in an alumina sagger provided with a lid.

The whole is introduced into a Naber 1800 furnace sold by Nabertherm, then heated to 1375° C. for 24 hours, with a temperature rise rate of 5° C./min and a temperature lowering rate of 5° C./min.

Each sintered pellet is then worked on a lapping machine in order to remove about 2 mm of thickness and thereby clear the core of the material. The pellet is then coated in a transparent resin and polished.

The X-ray diffraction measurements are then taken using a Bruker D5000 apparatus provided with a copper DX tube. The X-ray diffraction diagram is prepared with a step of 0.02° and acquisition of 4 seconds per step. In practice, these diagrams serve to detect:
a phase of the pyrochlore type La₂Zr₂O₇, of which the main peak diffracts at 2θ≈28.7° (datasheet ICDD 00-017-0450).
a cubic zirconia phase having a main diffracted peak at 2θ30.5° (datasheet ICDD 00-027-0997 or 01-049-1642).
one or more phases of type QaₐZr_{b}O_{c}. For example, when the element Qa of the (La_{(1-w-x-y)}Ln_{w}CeₓQa_{y})ₛ(Mn_{(1-z)}Qb_{z})O_{3-δ} perovskite is:
   calcium Ca, the phase to be identified is CaZrO₃;
   strontium Sr, the phase to be identified is SrZrO₃;
   barium Ba, the phase to be identified is BaZrO₃;
   a mixture of Ca and Sr, the phases to be identified may be CaZrO₃ and SrZrO₃;
one or more phases of type La_{d}QaₑZr_{f}Qb_{g}Oₕ. For example, this phase may be Ca_{0.9}Zr_{0.9}La_{0.2}O₃ or La(Mg_{0.5}Zr_{0.5})O_{3.}

Then, using the EVA software (sold by Bruker) and after having subtracted the background (background 0.8), it is possible to measure the area of the peak of pyrochlore type phase La₂Zr₂O₇ in the angular domain 28.4°<2θ<29.1°, the area of the peak of the cubic zirconia phase in the angular domain 29.3°<2θ<30.8° and the area of the peak of phase QaₐZr_{b}O_{c}, for example in the angular domain 30.9°<2θ<31.7° for the phase CaZrO₃, in the angular domain 30.5°<2θ<31.2° for the phase SrZrO₃, and in the angular domain 29.7<2θ<30.5 for the phase BaZrO_{3.}

The results are given in the form of the following ratios:
area (La₂Zr₂O₇)/[area (La₂Zr₂O₇)+Σ[areas (QaₐZr_{b}O_{c})]Σ[areas (La_{d}QaₑZr_{f}Qb_{g}Oₕ)]+area (cubic zirconia)]
(Σ[areas (QaₐZr_{b}O_{c})]+Σ[areas (La_{d}QaₑZr_{f}Qb_{g}Oₕ)])|[area (La₂Zr₂O₇)+Σ[areas (QaₐZr_{b}O_{c})]+Σ[areas (La_{d}QaₑZr_{f}Qb_{g}Oₕ)]+area (cubic zirconia)]
   For example, when the element Qa of the (La_{(1-w-x-y)}Ln_{w}CeₓQa_{y})ₛ(Mn_{(1-z)}Qb_{z})O_{3-δ} perovskite is:

calcium Ca, the phase (QaₐZr_{b}O_{c}) to be identified is CaZrO₃, and the results are given in the form of the following ratios:
area (La₂Zr₂O₇)/[area (La₂Zr₂O₇)+Σ[areas (CaZrO₃)]+Σ[areas (La_{d}CaₑZr_{f}Qb_{g}Oₕ)]+area (cubic zirconia)]
(Σ[areas (CaZrO₃)]+Σ[areas (La_{d}CaₑZr_{f}Qb_{g}Oₕ)])/[area (La₂Zr₂O₇)+Σ[areas (CaZrO₃)]+Σ[areas (La_{d}CaₑZr_{f}Qb_{g}Oₕ)]+area (cubic zirconia)]

strontium Sr, the phase (QₐZr_{b}O_{c}) to be identified is SrZrO₃, and the results are given in the form of the following ratios:
area (La₂Zr₂O₇)/[area (La₂Zr₂O₇)+Σ[areas (SrZrO₃)]+Σ[areas (La_{d}SrₑZr_{f}Qb_{g}Oₕ)]+area (cubic zirconia)]
(Σ[areas (SrZrO₃)]+Σ[areas (La_{d}SrₑZr_{f}Qb_{g}Oₕ)])/[area (La₂Zr₂O₇)+Σ[areas (SrZrO₃)]+Σ[areas (La_{d}SrₑZr_{f}Qb_{g}Oₕ)]+area (cubic zirconia)]

barium Ba, the phase to be identified is BaZrO₃, and the results are given in the form of the following ratios:
area (La₂Zr₂O₇)/[area (La₂Zr₂O₇)+Σ[areas (BaZrO₃)]+Σ[areas (La_{d}BaₑZr_{f}Qb_{g}Oₕ)]+area (cubic zirconia)]
(Σ[areas (BaZrO₃)]+Σ[areas (La_{d}BaₑZr_{f}Qb_{g}Oₕ)])/[area (La₂Zr₂O_{z})Σ[areas (BaZrO₃)]Σ[areas (La_{d}BaₑZr_{f}Qb_{g}Oₕ)]+area (cubic zirconia)].

The various powders of (La_{(1-w-x-y)}Ln_{w}CeₓQa_{y})ₛ(Mn_{(1-z)}Qb_{z})O_{3-δ} perovskite compared are the following:

A reference powder (comparative example) was fabricated by a method described in the fabrication of example 1 of U.S. Pat. No. 5,686,198 (different from fusion). In detail, the following powders were first mixed, as such, intimately using a spatula in a beaker:
112.04 g of La₂O₃ powder sold by TREIBACHER, having a purity higher than 99% by weight and a mean size of less than 45 μm;
12.45 g of CaO powder sold by LA GLORIETTE, having a purity higher than 93% by weight and of which the 80 μm mesh undersize is higher than 90%;
76.30 g of MnO₂ powder, sold by DELTA, having a purity higher than 91% by weight and a mean size of about 45 μm;
18.45 g of CeO₂ powder, sold by ALTICHEM, having a purity higher than 99% by weight and a maximum size of lower than 20 μm;
4.95 g of MgO powder sold by DELTAMAT PAQUET, having a purity higher than 99% by weight and a maximum size lower than 1 mm;

The quantities of the various powders used were calculated to obtain the desired (La_{(1-w-x-y)}Ln_{w}CeₓQa_{y})ₛ(Mn_{(1-z)}Qb_{z})O_{3-δ} perovskite after sintering.

The intimate mixture of powders is isostatically pressed in the form of a cylinder and sintered 3 times at 1500° C. in air for a holding time of 4 hours. After each sintering cycle, the pellet is ground to dryness, in a tungsten carbide roller mill for 50 s and then sieved to 160 μm to improve the chemical uniformity of the desired perovskite. The final powder, issuing from the third sintering, is ground by attrition so that it has a mean size of 0.25 micron.

The comparative example was compared with a powder of a molten perovskite product according to the invention, previously named “example 5”, not having undergone annealing treatment.

These perovskites have the following chemical composition:

TABLE 2

| Example | Composition |
|---|---|
| Comparative | (La_{0.682}Ce_{0.121}Ca_{0.197})_{0.923} Mn_{0.867}Mg_{0.133}O_{3-δ} |
| Example 5 | (La_{0.688}Ce_{0.107}Ca_{0.205}) Mn_{0.877}Mg_{0.123}O_{3-δ} |

Pellets were prepared from a mixture of each of these powders and of stabilized zirconia as describe above.

X-ray diffraction serves to identify the phases Ca_{0.9}Zr_{0.9}La_{0.2}O₃ and La(Mg_{0.5}Zr_{0.5})O₃ as phases of type (La_{d}CaₑZr_{f}Qb_{g}Oₕ), Table 3 therefore summarizes the measurements of the ratios:
“area (La₂Zr₂O₇)/[area (La₂Zr₂O₇)+area (CaZrO₃)+area (Ca_{0.9}Zr_{0.9}La_{0.2}O₃)+area (La(Mg_{0.5}Zr_{0.5})O₃)+area (cubic zirconia)]”, and
“(areas (CaZrO₃)+area (Ca_{0.9}Zr_{0.9}La_{0.2}O₃)+area (La(Mg_{0.5}Zr_{0.5})O₃)/[area (La₂Zr₂O₇)+area (CaZrO₃)+area (Ca_{0.9}Zr_{0.9}La_{0.2}O₃)+area (La(Mg_{0.5}Zr_{0.5})O₃)+area (cubic zirconia)]”:

TABLE 3

| | | Ratio of areas (CaZrO₃) + area |
|---|---|---|
| | Ratio of area (La₂Zr₂O₇)/[area | (Ca_{0.9}Zr_{0.9}La_{0.2}O₃) + area |
| | (La₂Zr₂O₇) + area (CaZrO₃) + | (La(Mg_{0.5}Zr_{0.5})O₃)/[area (La₂Zr₂O₇) + |
| | area (Ca_{0.9}Zr_{0.9}La_{0.2}O₃) + area | area (CaZrO₃) + area (Ca_{0.9}Zr_{0.9}La_{0.2}O₃) + |
| | (La(Mg_{0.5}Zr_{0.5})O₃) + area | area (La(Mg_{0.5}Zr_{0.5})O₃) + area |
| Example | (cubic zirconia)] | (cubic zirconia)] |
| Comparative | 0 | 3.88 |
| Example 5 | 0 | 0 |

Table 3 clearly shows that the powder of the molten perovskite product according to the invention has a ratio
(areas (CaZrO₃)+area (Ca_{0.9}Zr_{0.9}La_{0.2}O₃)+area (La(Mg_{0.5}Zr_{0.5})O₃)/[area (La₂Zr₂O₇)+area (CaZrO₃)+area (Ca_{0.9}Zr_{0.9}La_{0.2}O₃)+area (La(Mg_{0.5}Zr_{0.5})O₃)+area (cubic zirconia)]

comparatively much lower than the product of the perovskite powder obtained by a method other than fusion. In the products of the invention, the phases CaZrO₃, Ca_{0.9}Zr_{0.9}La_{0.2}O₃, La(Mg_{0.5}Zr_{0.5})O₃ may not even be identifiable.

Advantageously, the performance of the solid oxide fuel cells using these products is thereby improved.

1-80. (canceled)

81. A polycrystalline product obtained by fusion comprising:
the element lanthanum La,
an element Ln selected from the group consisting of praseodymium Pr, neodymium Nd, promethium Pm, samarium Sm, europium Eu, gadolinium Gd, terbium Tb, dysprosium Dy, holmium Ho, erbium Er, thulium Tm, ytterbium Yb, lutetium Lu, yttrium Y, and mixtures thereof,
the element cerium Ce,
an element Qa selected from the group consisting of calcium Ca, strontium Sr, barium Ba and mixtures thereof,
the element manganese Mn,
an element Qb selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof,
the element oxygen O,
the product having a chemical composition such that, by denoting:
Laₚ the molar content of lanthanum;
Mnₚ the molar content of manganese;
Lnₚ the molar content of the element Ln;
Ceₚ the molar content of cerium;
Qaₚ the molar content of element Qa;
Qbₚ the molar content of element Qb;
these contents being expressed as molar percentages on the basis of the total molar quantity of the elements La, Ln, Ce, Qa, Mn, Qb, and by setting
s=(Laₚ+Lnₚ+Ceₚ+Qaₚ)/(Mnₚ+Qbₚ),
z=Qbₚ/(Mnₚ+Qbₚ),
w=Lnₚ/(Laₚ+Lnₚ+Ceₚ+Qaₚ),
x=Ceₚ/(Laₚ+Lnₚ+Ceₚ+Qaₚ), and
y=Qaₚ/(Laₚ+Lnₚ+Ceₚ+Qaₚ),
the product having, not including impurities, a proportion of perovskite having the formula (La_{(1-w-x-y)}Ln_{w}CeₓQa_{y})ₛ(Mn_{(1-z)}Qb_{z})O_{3-δ} higher than 30%, w, x, y, z and s being molar proportions and δ being determined in order to guarantee the electroneutrality of said perovskite,
the chemical composition of said product being such that
0≦w≦0.4, and
0≦x≦0.4, and
0.1≦y≦0.6, and
0<z≦0.5, and
0.8≦s≦1.25.

82. The product as claimed in claim 81, in which 0.85≦s≦1.15.

83. The product as claimed in claim 82, in which 0.9≦s≦1.1.

84. A polycrystalline product obtained by fusion comprising:
the element lanthanum La,
an element Ln selected from the group consisting of praseodymium Pr, neodymium Nd, promethium Pm, samarium Sm, europium Eu, gadolinium Gd, terbium Tb, dysprosium Dy, holmium Ho, erbium Er, thulium Tm, ytterbium Yb, lutetium Lu, yttrium Y, and mixtures thereof,
the element cerium Ce,
an element Qa selected from the group consisting of calcium Ca, strontium Sr, barium Ba and mixtures thereof,
the element manganese Mn,
an element Qb selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof,
the element oxygen O,
the product having a chemical composition such that, by denoting:
Laₚ the molar content of lanthanum;
Mnₚ the molar content of manganese;
Lnₚ the molar content of the element Ln;
Ceₚ the molar content of cerium;
Qaₚ the molar content of element Qa;
Qbₚ the molar content of element Qb;
these contents being expressed as molar percentages on the basis of the total molar quantity of the elements La, Ln, Ce, Qa, Mn, Qb, and by setting
s=(Laₚ+Lnₚ+Ceₚ+Qaₚ)/(Mnₚ+Qbₚ),
z=Qbₚ/(Mnₚ+Qbₚ),
w=Lnₚ/(Laₚ+Lnₚ+Ceₚ+Qaₚ),
x=Ceₚ/(Laₚ+Lnₚ+Ceₚ+Qaₚ), and
y=Qaₚ/(Laₚ+Lnₚ+Ceₚ+Qaₚ),
the chemical composition of said product being such that
0≦w≦0.4, and
0≦x≦0.4, and
0.1≦y≦0.6, and
z=0, and
z=0, and
1.1<s≦1.25.

85. A polycrystalline product obtained by fusion comprising:
the element lanthanum La,
an element Ln selected from the group consisting of praseodymium Pr, neodymium Nd, promethium Pm, samarium Sm, europium Eu, gadolinium Gd, terbium Tb, dysprosium Dy, holmium Ho, erbium Er, thulium Tm, ytterbium Yb, lutetium Lu, yttrium Y, and mixtures thereof, and Ln is not yttrium and/or ytterbium,
the element cerium Ce,
an element Qa selected from the group consisting of calcium Ca, strontium Sr, barium Ba and mixtures thereof,
the element manganese Mn,
an element Qb selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof,
the element oxygen O,
the product having a chemical composition such that, by denoting:
Laₚ the molar content of lanthanum;
Mnₚ the molar content of manganese;
Lnₚ the molar content of the element Ln;
Ceₚ the molar content of cerium;
Qaₚ the molar content of element Qa;
Qbₚ the molar content of element Qb;
these contents being expressed as molar percentages on the basis of the total molar quantity of the elements La, Ln, Ce, Qa, Mn, Qb, and by setting
s=(Laₚ+Lnₚ+Ceₚ+Qaₚ)/(Mnₚ+Qbₚ),
z=Qbₚ/(Mnₚ+Qbₚ),
w=Lnₚ/(Laₚ+Lnₚ+Ceₚ+Qaₚ),
x=Ceₚ/(Laₚ+Lnₚ+Ceₚ+Qaₚ), and
y=Qaₚ/(Laₚ+Lnₚ+Ceₚ+Qaₚ),
the chemical composition of said product being such that
0<w≦0.4, and
0≦x≦0.4, and
0.1≦y≦0.6, and
z=0 et
0.8≦s≦1.1.

86. A polycrystalline product obtained by fusion comprising:
the element lanthanum La,
an element Ln selected from the group consisting of ytterbium Yb, yttrium Y, and mixtures thereof,
the element cerium Ce,
an element Qa selected from the group consisting of calcium Ca, strontium Sr, barium Ba and mixtures thereof,
the element manganese Mn,
an element Qb selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof,
the element oxygen O,
the product having a chemical composition such that, by denoting:
Laₚ the molar content of lanthanum;
Mnₚ the molar content of manganese;
Lnₚ the molar content of the element Ln;
Ceₚ the molar content of cerium;
Qaₚ the molar content of element Qa;
Qbₚ the molar content of element Qb;
these contents being expressed as molar percentages on the basis of the total molar quantity of the elements La, Ln, Ce, Qa, Mn, Qb, and by setting
s=(Laₚ+Lnₚ+Ceₚ+Qaₚ)/(Mnₚ+Qbₚ),
z=Qbₚ/(Mnₚ+Qbₚ),
w=Lnₚ/(Laₚ+Lnₚ+Ceₚ+Qaₚ),
x=Ceₚ/(Laₚ+Lnₚ+Ceₚ+Qaₚ), and
y=Qaₚ/(Laₚ+Lnₚ+Ceₚ+Qaₚ),
the chemical composition of said product being such that
0<w≦0.4, and
0≦x≦0.4, and
0.1≦y≦0.6, and
z=0 et
0.8≦s≦1.1 and
x+y+w>0.6875.

87. A polycrystalline product obtained by fusion comprising:
the element lanthanum La,
an element Ln selected from the group consisting of praseodymium Pr, neodymium Nd, promethium Pm, samarium Sm, europium Eu, gadolinium Gd, terbium Tb, dysprosium Dy, holmium Ho, erbium Er, thulium Tm, ytterbium Yb, lutetium Lu, yttrium Y, and mixtures thereof,
the element cerium Ce,
an element Qa selected from the group consisting of calcium Ca, strontium Sr, barium Ba and mixtures thereof,
the element manganese Mn,
an element Qb selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof,
the element oxygen O,
the product having a chemical composition such that, by denoting:
Laₚ the molar content of lanthanum;
Mnₚ the molar content of manganese;
Lnₚ the molar content of the element Ln;
Ceₚ the molar content of cerium;
Qaₚ the molar content of element Qa;
Qbₚ the molar content of element Qb;
these contents being expressed as molar percentages on the basis of the total molar quantity of the elements La, Ln, Ce, Qa, Mn, Qb, and by setting
s=(Laₚ+Lnₚ+Ceₚ+Qaₚ)/(Mnₚ+Qbₚ),
z=Qbₚ/(Mnₚ+Qbₚ),
w=Lnₚ/(Laₚ+Lnₚ+Ceₚ+Qaₚ),
x=Ceₚ/(Laₚ+Lnₚ+Ceₚ+Qaₚ), and
y=Qaₚ/(Laₚ+Lnₚ+Ceₚ+Qaₚ),
the chemical composition of said product is such that
w=0, and
0≦x≦0.4, and
0.1≦y≦0.6, and
z=0 and
0.8≦s≦1.1, and
(x+y).s>0.55.

88. The product as claimed in claim 81, in which the element Qa is selected from the group consisting of calcium Ca, strontium Sr, barium Ba and mixtures thereof; the element Qb selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof, and,
0.05≦x≦0.25,
0.1≦x+y≦0.7,
0<z≦0.5, and
0.8≦s≦1.25.

89. The product as claimed in claim 81, in which the element Qa is selected from the group consisting of calcium Ca, strontium Sr, barium Ba and mixtures thereof; the element Qb selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof, and
w=0, and
0.05≦x≦0.25, and
0.1≦x+y≦0.7, and
0<z≦0.5, and
0.8≦s≦1.25.

90. The product as claimed in claim 84 in which the element Qa is selected from the group consisting of calcium Ca, strontium Sr, barium Ba and mixtures thereof; the element Qb selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof, and
w=0, and
0.05≦x≦0.25, and
0.1≦x+y≦0.7, and
z=0, and
1.1<s≦1.25

91. The product as claimed in claim 87, in which the element Qa is selected from the group consisting of calcium Ca, strontium Sr, barium Ba and mixtures thereof; the element Qb selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof, and
w=0, and
0.05≦x≦0.25, and
0.1≦x+y≦0.7, and
z=0, and
0.8≦s≦1.1

92. The product as claimed in claim 88, in which 0.1≦x≦0.2.

93. The product as claimed in claim 88, in which 0.4≦x+y≦0.7.

94. The product as claimed in claim 88, in which the element Qa is calcium Ca.

95. The product as claimed in claim 88, in which 0.9≦s≦1.

96. The product as claimed in claim 95, in which 0.95≦s≦1.

97. The product as claimed in claim 87, in which z=0 and 0.8≦s≦0.9.

98. The product as claimed in claim 87, in which z=0 and 0.5≦x+y≦0.7.

99. The product as claimed in claim 81, in which the element Qa is calcium Ca, the element Qb is chromium Cr, and,
0.18≦y≦0.4, and
0.05≦z≦0.15, and
0.8≦s≦1.25.

100. The product as claimed in claim 99, in which the element Qa is calcium Ca, the element Qb is chromium Cr, and
w=0, and
x=0.

101. The product as claimed in claim 99, in which 0.9≦s≦1.

102. The product as claimed in claim 101, in which 0.95≦s≦1.

103. The product as claimed in claim 81, in which the element Qa is selected from the group consisting of calcium Ca, strontium Sr, and mixtures thereof, and,
0.01≦x≦0.047, and
0.155≦y≦0.39, and
0.8≦s≦1.25.

104. The product as claimed in claim 84, in which the element Qa is selected from the group consisting of calcium Ca, strontium Sr, and mixtures thereof, and,
w=0, and
0.01≦x≦0.047, and
0.155≦y≦0.39, and
z=0, and
0.8≦s≦1.25.

105. The product as claimed in claim 103, in which 0.9≦s≦1.

106. The product as claimed in claim 105, in which 0.95≦s≦1.

107. The product as claimed in claim 106, in which 0.96≦s≦0.995.

108. The product as claimed in claim 103, in which 0.8≦s<0.9.

109. The product as claimed in claim 81, in which the element Qa is selected from the group consisting of calcium Ca, strontium Sr, and mixtures thereof; the element Qb is selected from the group consisting of nickel Ni, chromium Cr, and mixtures thereof, and,
0≦x≦0.205, and
0.15≦y≦0.25, and
0.03≦z≦0.2, and
0.8≦s≦1.25.

110. The product as claimed in claim 109 , in which
w=0.

111. The product as claimed in claim 109, in which 0.9≦s≦1.

112. The product as claimed in claim 111, in which 0.95≦s≦1.

113. The product as claimed in claim 109, in which y=0.2.

114. The product as claimed in claim 81, in which the element Ln is selected from the group consisting of praseodymium Pr, neodymium Nd, promethium Pm, samarium Sm, europium Eu, gadolinium Gd, terbium Tb, dysprosium Dy, holmium Ho, erbium Er, thulium Tm, ytterbium Yb, lutetium Lu, and mixtures thereof; the element Qa is selected from the group consisting of calcium Ca, strontium Sr, barium Ba, and mixtures thereof; the element Qb is selected from the group consisting of magnesium Mg, nickel Ni, chromium Cr, aluminum Al, iron Fe, and mixtures thereof, and
0.05≦w≦0.4, and
0≦x≦0.4, and
0.1≦y≦0.2, and
0.05≦z≦0.1, and
0.8≦s≦1.25.

115. The product as claimed in claim 114, in which the element Ln is selected from the group consisting of praseodymium Pr, neodymium Nd, samarium Sm, and mixtures thereof.

116. The product as claimed in claim 114, in which the element Qa is calcium.

117. The product as claimed in claim 114, in which the element Qb is selected from the group consisting of nickel Ni, magnesium Mg and mixtures thereof.

118. The product as claimed in claim 114, in which 0.05≦w≦0.3.

119. The product as claimed in claim 118, in which 0.05≦w≦0.2.

120. The product as claimed in claim 114, in which 0≦x≦0.3.

121. The product as claimed in claim 120, in which 0≦x≦0.2.

122. The product as claimed in claim 114, in which 0.9≦s≦1.

123. The product as claimed in claim 122, in which 0.95≦s≦1.

124. The product as claimed in claim 81, in which the element Ln is selected from the group consisting of neodymium Nd, samarium Sm, gadolinium Gd, dysprosium Dy, erbium Er, yttrium Y, and mixtures thereof, and the element Qa is calcium Ca, and,
0.005≦w≦0.4, and
0.005≦x≦0.02, and
0.1≦y≦0.6, and
0.8≦s≦1.25.

125. The product as claimed in claim 84, in which the element Ln is selected from the group consisting of neodymium Nd, samarium Sm, gadolinium Gd, dysprosium Dy, erbium Er, yttrium Y, and mixtures thereof, and the element Qa is calcium Ca, and
0.005≦w≦0.4, and
0.005≦x≦0.02, and
0.1≦y≦0.6, and
z=0, and
0.8≦s≦1.25.

126. The product as claimed in claim 124, in which the element Ln consists of an element selected from the group consisting of samarium Sm, gadolinium Gd, dysprosium Dy, erbium Er, and mixtures thereof.

127. The product as claimed in claim 126, in which the element Ln consists of samarium Sm.

128. The product as claimed in claim 124, in which 0.175≦w≦0.185.

129. The product as claimed in claim 124, in which 0.255≦y≦0.265.

130. The product as claimed in claim 124, in which 1≦s≦1.02.

131. The product as claimed in claim 130, in which 1.001≦s≦1.01.

132. The product as claimed in claim 124 in which 0.55≦1-w-x-y≦0.56.

133. The product as claimed in claim 81, in which the element Qa is calcium Ca, and,
0.1≦x≦0.2, and
0.2≦y≦0.55, and
0.8≦s≦1.25.

134. The product as claimed in claim 84, in which the element Qa is calcium Ca, and
w=0, and
0.1≦x≦0.2, and
0.2≦y≦0.55.

135. The product as claimed in claim 133, in which 0.9≦s≦1.

136. The product as claimed in claim 135, in which 0.95≦s≦1.

137. The product as claimed in claim 133, in which 0.5<x+y≦0.75.

138. The product as claimed in claim 81, in which the weight content of impurities is lower than 1.5%.

139. The product as claimed in claim 138, in which the weight content of impurities is lower than 1%.

140. The product as claimed in claim 139, in which the weight content of impurities is lower than 0.7%.

141. The product as claimed in claim 84, having; not including impurities, a proportion of perovskite having the formula La_{(1-w-x-y)}Ln_{w}CₓQa_{ys}Mn_{(1-z)}Qb_{z}O_{3-δ} higher than 30%, w, x, y, z and s being molar proportions and satisfying any one of the conditions mentioned in any one of the precedent claims, and δ being determined in order to ensure the electroneutrality of said perovskite.

142. The product as claimed in claim 141, in which said proportion of perovskite is higher than 85%.

143. The product as claimed in claim 142, in which said proportion of perovskite is higher than 90%.

144. The product as claimed in claim 143, in which said proportion of perovskite is higher than 95%.

145. The product as claimed in claim 144, in which said proportion of perovskite is higher than 99%.

146. The product as claimed in claim 145, in which said proportion of perovskite is 100%.

147. The product as claimed in claim 81, in which the elements La, Ln, Ce, Qa, Mn, Qb, and O account for a total of more than 95% of said product, in weight percent.

148. The product as claimed in claim 147, in which the elements La, Ln, Ce, Qa, Mn, Qb, and O account for a total of over 98.5% of said product.

149. The product as claimed in claim 148, in which the elements La, Ln, Ce, Qa, Mn, Qb, and O account for a total of over 99% of said product.

150. The product as claimed in claim 149, in which the elements La, Ln, Ce, Qa, Mn, Qb, and O account for a total of over 99.3% of said product.

151. The product as claimed in claim 81, in which the molar content Oₚ of the element oxygen, in molar percent on the basis of the total molar quantity of the elements La, Ln, Ce, Qa, Mn, Qb, O, is such that 2/(3+s)≦Oₚ≦4/(5+s).

152. The product as claimed in claim 151, in which the molar content Oₚ of the element oxygen, in molar percent on the basis of the total molar quantity of the elements La, Ln, Ce, Qa, Mn, Qb, O, is such that
2.5/(3.5+s)≦Oₚ≦3.5/(4.5+s).

153. The product as claimed in claim 152, in which the molar content Oₚ of the element oxygen, in molar percent on the basis of the total molar quantity of the elements La, Ln, Ce, Qa, Mn, Qb, O, is such that
2.7/(3.7+s)≦Oₚ≦3.3/(4.3+s).

154. The product as claimed in claim 153, in which the molar content Oₚ of the element oxygen, in molar percent on the basis of the total molar quantity of the elements La, Ln, Ce, Qa, Mn, Qb, O, is such that
2.85/(3.85+s)≦Oₚ≦3.15/(4.15+s).

155. A method for fabricating a molten product comprising the following steps:
mixing of raw materials providing lanthanum, manganese, optionally oxygen, an element Qa and an element Ln and/or an element Qb and/or optionally cerium, to form a starting charge,
the element Qa being selected from the group consisting of calcium Ca, strontium Sr, barium Ba and mixtures thereof,
the element Ln being selected from the group consisting of praseodymium Pr, neodymium Nd, promethium Pm, samarium Sm, europium Eu, gadolinium Gd, terbium Tb, dysprosium Dy, holmium Ho, erbium Er, thulium Tm, ytterbium Yb, lutetium Lu, yttrium Y, and mixtures thereof,
the element Qb being selected from the group consisting of magnesium Mg, nickel Ni, chromium Cr, aluminum Al, iron Fe, cobalt Co, titanium Ti, tin Sn, tantalum Ta, indium In, niobium Nb and mixtures thereof,
melting of the starting charge until a bath of melting material is obtained;
cooling to complete solidification of said melting material,
the raw materials being selected so that the solid product obtained after step c) conforms to claim 81.

156. The method as claimed in claim 155, in which step c) comprises the following steps:
c₁) dispersion of the melting material in the form of liquid droplets,
d₁) solidification of these liquid droplets by contact with an oxygen-containing fluid, in order to obtain molten particles.

157. The method as claimed in claim 155, in which step c) comprises the following steps:
c₂) pouring of said melting material into a mold;
d₂) solidification by cooling of the material poured into the mold until an at least partially solidified block is obtained;
e₂) stripping of the block.

158. The method as claimed in claim 155, in which in step c₁) and/or in step d₁), or in step c₂) and/or in step d₂) and/or after step e₂), said melting material in the course of solidification is placed in contact, directly or indirectly, with an oxygen-containing fluid.

159. The method as claimed in claim 158, said oxygen-containing fluid comprising at least 25% by volume of oxygen.

160. The method as claimed in claim 158, in which the stripping of step e₂) is carried out before complete solidification of the block, said contact is initiated immediately after stripping the block, and said contact is maintained until complete solidification of the block.

161. The method as claimed in claim 155 , in which, after step d₁) or after step e₂), the particles or the block obtained are/is annealed, at a temperature of between 1050° C. and 1700° C.

162. A cathode for solid oxide fuel cells comprising a product as claimed in claim 81.
